(19) United States
(12) Patent Application Publication
(10) Pub. No.: US 2026/0073819 A1
(43) Pub. Date: Mar. 12, 2026

(54) SYSTEMS AND METHODS FOR DEPLOYING AND HOUSING A FLAG

(71) Applicant: Linker Enterprises, Inc., Morro Bay, CA (US)

(72) Inventor: Jon Jason Linker, Morro Bay, CA (US)

(73) Assignee: Linker Enterprises, Inc., Morro Bay, CA (US)

(21) Appl. No.: 19/326,460

(22) Filed: Sep. 11, 2025

Related U.S. Application Data
(60) Provisional application No. 63/693,662, filed on Sep. 11, 2024.
(60) Provisional application No. 63/694,799, filed on Sep. 14, 2024.

(51) Int. Cl. G09F 17/00

(52) U.S. Cl. CPC G09F 17/00; G09F 2017/0025; G09F 2017/0075

(57) ABSTRACT

A flag housing and deployment system includes: a housing with a hollow interior between proximal and distal ends; an elongated member positioned within the housing and configured to couple to a flag at a distal end of the elongated member; and an actuation system operably coupled to the elongated member. The actuation system is configured to: move the elongated member from the housed to deployed position based on an occurrence of a first triggering event; and move the elongated member from the deployed to housed position based on an occurrence of a second event. In the deployed position, the elongated member extends out of the distal end of the housing such that the flag and the distal end of the elongated member are outside of the housing. In the housed position, the elongated member is positioned within the housing such that the flag is housed within the housing.

### CROSS-REFERENCE TO RELATED APPLICATIONS

This application claims the benefit of U.S. Provisional Application No. 63/693,662, filed Sep. 11, 2024, and U.S. Provisional Application No. 63/694,799, filed Sep. 14, 2024, the entireties of which are both incorporated herein by reference.

### FIELD OF THE INVENTION

The subject matter of the present disclosure relates generally to the field of flags. More particularly, the present disclosure relates to flag deployment systems.

### BACKGROUND OF THE INVENTION

Flags are used throughout society for all types of purposes, including being used as a symbol, decoration, insignia of one's identity, and a signal or message of communication. Generally, flags are displayed using some form of pole to enable them to be raised up in the air when flown. Flags are typically flown by manually raising the flag up the flag pole, such as with a rope and pulley system connected to a flag pole. In many instances, flags are attached to one end of a flag pole or stick and used in portable or hand-held applications by people. In such cases, people would manually raise the entire flag pole in order to raise the flag in the air when the intended purpose is desired. For example, when a hazard or concern exists, a person may raise a flag being used as cautionary symbol to signal to others to be careful when the flag is being flown, and then when the hazard or concern is no longer present, the person may lower the flag to put it away. In such applications, the flag may be manually raised and lowered frequently.

One common application in which flags are raised and lowered is with water sports, and in particular towed water sports where a participant is towed being a boat. Example well-known towed water sports include water skiing, wakeboarding, wakesurfing, hydrofoiling, kneeboarding, tubing, and skurfing, just to name a few. Typically, a cautionary flag (or “skier-down” flag, “participant-in-water” flag, etc.) is raised when the participant is not riding behind the boat but is in the water, such as when preparing to start to ride or when having fallen into the water while riding. The raised flag signals to people in other boats in the vicinity to be careful because a person (e.g., the participant) is in the water. The other boats may then decide to steer away from the location of the participant in the water. Once the participant is out of the water (e.g., riding behind the boat again, back in the boat, etc.), the flag can be lowered out of sight. The role of raising and lower the flag is often done by someone in the boat towing the participant—referred to herein as the “flagger”. Generally, people in the boat are there for the enjoyment of riding in the boat, looking at the scenery, talking with others, watching the participant, etc. As a result, being designated as the flagger can sometimes be viewed as a mild inconvenience or burden to the person selected because they now have duties and responsibilities that they must fulfill. Further raising the flag and holding it in the air can be tiring if done repeatedly or over a long time period. Still further, the flagger may not perform their duties very well. For instance, the flagger may be distracted or not pay attention, may forget to raise or lower the flag, may not raise the flag high enough to be seen, etc. This can not only take away enjoyment of the flagger, but can also put the safety of the participant in jeopardy.

### SUMMARY OF THE INVENTION

In one aspect of the present disclosure, a flag housing and deployment system is provided that includes: a housing including a hollow interior between a proximal end and a distal end of the housing; an elongated member positioned within the housing and configured to couple to a flag at a distal end of the elongated member; and an actuation system operably coupled to the elongated member. The actuation system is configured to: move the elongated member from the housed position to a deployed position based on an occurrence of a first triggering event; and move the elongated member from the deployed position to a housed position based on an occurrence of a second event. In the deployed position, the elongated member extends out of the distal end of the housing such that the flag and the distal end of the elongated member are outside of the housing. In the housed position, the elongated member is positioned within the housing such that the flag is housed within the housing.

In an embodiment, the flag housing and deployment system further includes: a stabilizing guide positioned within the housing and configured to move within the housing; and a stop element coupled to the housing and configured to contact and stop the stabilizing guide when sliding towards the distal end of the housing. The stabilizing guide includes a hole extending through the stabilizing guide. The elongated member is positioned extending through the hole of the stabilizing guide. The elongated member and the stabilizing guide are configured such that movement of the elongated member from the housed position to the deployed position includes: the elongated member moving with the stabilizing guide towards the distal end of the housing until the stop element contacts and stops the stabilizing guide; and after the stop element contacts and stops the stabilizing guide, the elongated member continues to move and slides through the hole of the stabilizing element to reach the deployed position.

In an embodiment, the elongated member and the hole are frictionally fit. The frictional fit is overcome when the stop element contacts and stops the stabilizing guide during movement of the elongated member from the housed position to the deployed position.

In an embodiment, the stabilizing guide occupies the cross-sectional area of the housing.

In an embodiment, the actuation system includes: an energy source for providing energy to move the elongated member to the housed and deployed positions; one or more input devices; and a processor communicatively coupled to the energy source and the one or more input devices. The processor is configured to: receive input from one or more input devices; determine when the first and second triggering events occur based on the input; trigger movement of the elongated member, using the energy, to the deployed position based on a determination that the first triggering event has occurred; and trigger movement of the elongated member to the housed position, using the energy, based on a determination that the second triggering event has occurred.

In an embodiment, the one or more input devices include a local or remote device that enables a user to indicate the occurrence of the first and second events via the local or remote device. The input received by the processor includes input from the local or remote device.

In an embodiment, the flag housing and deployment system of claim 9, wherein the one or more input devices are configured to provide a state indicator to indicate the deployed and housed positions via at least one selected from: a light source, LED, icon, symbol, color, and text. In an embodiment, the one or more input devices include a remote button having an integrated state indicator to indicate the deployed and housed positions via the at least one selected from: a light source, LED, icon, symbol, color, and text. In an embodiment, more than one of the input devices are daisy-chained with category (or CAT) cables.

In an embodiment, the one or more input devices further includes one or more sensors. The input received by the processor includes sensor data from the one or more sensors.

In an embodiment, the one or more sensors includes at least one selected from the group consisting of: a revolutions per minute (RPM) sensor, a tilt sensor, a proximity sensor, an image sensor, a global positioning system (GPS) sensor, a speed sensor, and an accelerometer sensor.

In an embodiment, the flag housing and deployment system further includes an air cylinder having a piston coupled to the elongated member. The actuation system includes: a compressor and a motor as the energy source; and a control valve coupled to the compressor and to the air cylinder via hoses to enable air from the compressor to enter the air cylinder to move the piston in opposite directions.

In an embodiment, the flag housing and deployment system further includes: a motor; a screw coupled to the motor; and a nut threaded to fit on the screw. The nut is coupled to the elongated member and prevented from rotating within the housing. The nut is configured to move in opposite directions within the housing based on a direction that the motor rotates the screw.

In an embodiment, the flag housing and deployment system further includes a linear actuator configured to move the elongated member to the housing and deployed positions.

In an embodiment, the one or more sensors include an image sensor for generating image data of a participant behind a boat. The processor is configured to: receive and process the image data from the image sensor; based on the processing of the image data, determine that the first triggering event has occurred, wherein the first triggering event represents that the participant behind the boat is in the water and not riding behind the boat; and based on the determination that the first triggering event has occurred, trigger the actuation system to move the elongated member to the deployed position.

In an embodiment, the processor is further configured to: based on the processing of the image data, determine that the second triggering event has occurred, wherein the second triggering event represents that the participant is riding behind the boat; and based on the determination that the second triggering event has occurred, trigger the actuation system to move the elongated member to the housed position.

In an embodiment, the one or more sensors include a proximity sensor for generating proximity data of a participant behind a boat. The processor is configured to: receive and process the proximity data from the proximity sensor; based on the processing of the proximity data, determine that the first triggering event has occurred, wherein the first triggering event represents that the participant behind the boat is in the water and not riding behind the boat; and based on the determination that the first triggering event has occurred, trigger the actuation system to move the elongated member to the deployed position.

In an embodiment, the processor is further configured to: based on the processing of the proximity data, determine that the second triggering event has occurred, wherein the second triggering event represents that the participant is riding behind the boat; and based on the determination that the second triggering event has occurred, trigger the actuation system to move the elongated member to the housed position.

In an embodiment, the one or more sensors include a tilt sensor for generating tilt data of a boat. The processor is configured to: receive and process the tilt data from the tilt sensor; based on the processing of the proximity data, determine that the first triggering event has occurred, wherein the first triggering event represents that the boat is tilted less than a first threshold degree of tilt; and based on the determination that the first triggering event has occurred, trigger the actuation system to move the elongated member to the deployed position.

In an embodiment, the processor is further configured to: based on the processing of the tilt data, determine that the second triggering event has occurred, wherein the second triggering event represents that the boat is tilted greater than a second threshold degree of tilt; and based on the determination that the second triggering event has occurred, trigger the actuation system to move the elongated member to the housed position.

In an embodiment, the one or more sensors include a revolutions per minute (RPM) sensor for generating RPM data of a boat. The processor is configured to: receive and process the RPM data from the RPM sensor; based on the processing of the proximity data, determine that the first triggering event has occurred, wherein the first triggering event represents that an engine of the boat has decreased below a first threshold value of RPMs; and based on the determination that the first triggering event has occurred, trigger the actuation system to move the elongated member to the deployed position.

In an embodiment, the processor is further configured to: based on the processing of the RPM data, determine that the second triggering event has occurred, wherein the second triggering event represents that the engine of the boat has increased above a second threshold value of RPMs; and based on the determination that the second triggering event has occurred, trigger the actuation system to move the elongated member to the housed position.

In an embodiment, the one or more sensors include a global positioning system (GPS) sensor for generating GPS data of a boat. The processor is configured to: receive and process the GPS data from the GPS sensor; based on the processing of the GPS data, determine that the first triggering event has occurred, wherein the first triggering event represents that a speed or acceleration of the boat has decreased below a first threshold value; and based on the determination that the first triggering event has occurred, trigger the actuation system to move the elongated member to the deployed position.

In an embodiment, the processor is further configured to: based on the processing of the GPS data, determine that the second triggering event has occurred, wherein the second triggering event represents that the speed or acceleration of the boat has increased above a second threshold value; and based on the determination that the second triggering event has occurred, trigger the actuation system to move the elongated member to the housed position.

In an embodiment, the one or more sensors include a speed sensor for generating speed data of a boat. The processor is configured to: receive and process the speed data from the speed sensor; based on the processing of the speed data, determine that the first triggering event has occurred, wherein the first triggering event represents that a speed of the boat has decreased below a first threshold value; and based on the determination that the first triggering event has occurred, trigger the actuation system to move the elongated member to the deployed position.

In an embodiment, the processor is further configured to: based on the processing of the speed data, determine that the second triggering event has occurred, wherein the second triggering event represents that the speed of the boat has increased above a second threshold value; and based on the determination that the second triggering event has occurred, trigger the actuation system to move the elongated member to the housed position.

In an embodiment, the one or more sensors include an accelerometer sensor for generating acceleration data of a boat. The processor is configured to: receive and process the acceleration data from the accelerometer sensor; based on the processing of the acceleration data, determine that the first triggering event has occurred, wherein the first triggering event represents that an acceleration of the boat has decreased below a first threshold value; and based on the determination that the first triggering event has occurred, trigger the actuation system to move the elongated member to the deployed position.

In an embodiment, the processor is further configured to: based on the processing of the acceleration data, determine that the second triggering event has occurred, wherein the second triggering event represents that the acceleration of the boat has increased above a second threshold value; and based on the determination that the second triggering event has occurred, trigger the actuation system to move the elongated member to the housed position.

In an embodiment, the one or more sensors includes two or more sensors selected from the group consisting of: an image sensor, a proximity sensor, an attitude sensor, and a revolutions per minute (RPM) sensor. The processor is further configured to: based on the processing of data from the two or more sensors, determine that the first triggering event has occurred; and based on the determination that the first triggering event has occurred, trigger the actuation system to move the elongated member to the deployed position.

In an embodiment, the processor is further configured to: based on the processing of data from the two or more sensors, determine that the second triggering event has occurred; and based on the determination that the second triggering event has occurred, trigger the actuation system to move the elongated member to the housed position.

In an embodiment, the flag housing and deployment system further includes an air cylinder having a piston coupled to the elongated member. The actuation system includes: a compressor and a motor as the energy source; and a control valve coupled to the compressor and to the air cylinder via hoses to enable air from the compressor to enter the air cylinder to move the piston in opposite directions. The air cylinder includes: a first port disposed on one side of the piston to move the piston in a first direction; and a second port disposed on an opposite side of the piston to move the piston in a second direction opposite the first direction. The flag housing and deployment system further includes: first and second hoses coupled to the compressor and extending to the first and second ports, respectively; and first and second clamps coupled to the housing and configured to couple to a structure of a boat. The first clamp include a first hole for receiving the first hose. The second clamp include a second hole for receiving the second hose. The first hole is configured to align with a third hole in the housing such that the first hose is extendable from within the structure of the boat to the first port of the cylinder in the housing. The second hole is configured to align with a fourth hole in the housing such that the second hose is extendable from within the structure of the boat to the second port of the cylinder within the housing.

In an embodiment, the flag housing and deployment system further includes a flag coupled to the distal end of the elongated member.

In an embodiment, the flag has a shape of a parallelogram.

In an embodiment, the flag includes a sleeve to fit over the elongated member.

In an embodiment, the flag includes a zipper or hook and latch (e.g., Velcro) connection that enables the flag to be removed.

In an embodiment, the housing is integrated in a structure of a boat.

In an embodiment, the flag housing and deployment system further includes a trim ring having a top and bottom plate that are configured to couple to opposite sides of a fabric material of a top or cover of a boat to enable: the fabric material within the interior of the top and bottom rings to be cut out without disturbing the rest of the top or cover; and the elongated member to extend through the top or cover of the boat via the interior of the top and bottom plates in the deployed position.

In an aspect of the present of the present disclosure, a machine-implemented method for housing and deploying the flag housing and deployment systems described above are provided. The method includes receiving input from one or more input devices. The actuation system includes: an energy source for providing energy to move the elongated member to the housed and deployed positions; and the one or more input devices. The method further includes: determining when the first and second triggering events has occurred based on the input; triggering movement of the elongated member, using the energy from the energy source, to the deployed position based on a determination that the first triggering event has occurred; and triggering movement of the elongated member to the housed position, using the energy, based on a determination that the second triggering event has occurred.

In an aspect of the present of the present disclosure, a flag housing and deployment system is provided that includes: a housing including a hollow interior between a proximal end and a distal end of the housing; an elongated member positioned within the housing and configured to couple to a flag at a distal end of the elongated member; and means for pneumatic actuation of the elongated member to housed and deployed positions based on an occurrence of first and second triggering events, respectively. In the deployed position, the elongated member extends out of the distal end of the housing such that the flag and the distal end of the elongated member are outside of the housing. In the housed position, the elongated member is positioned within the housing such that the flag is housed within the housing.

In an aspect of the present of the present disclosure, a flag housing and deployment system is provided that includes: a housing including a hollow interior between a proximal end and a distal end of the housing; an elongated member positioned within the housing and configured to couple to a flag at a distal end of the elongated member; and means for linear actuation of the elongated member to housed and deployed positions based on an occurrence of first and second triggering events, respectively. In the deployed position, the elongated member extends out of the distal end of the housing such that the flag and the distal end of the elongated member are outside of the housing. In the housed position, the elongated member is positioned within the housing such that the flag is housed within the housing.

### BRIEF DESCRIPTION OF DRAWINGS

For a better understanding of at least certain embodiments, reference will be made to the following Detailed Description, which is to be read in conjunction with the accompanying drawings.

FIG. 1 illustrates a functional block diagram of an example flag housing and deployment system, according to an embodiment.

FIGS. 2A and 2B illustrate diagrams of example flag housing and deployment systems with different example actuation systems, according to some embodiments.

FIG. 3 illustrates a diagram of an example flag housing and deployment system coupled to a boat, according to an embodiment.

FIG. 4 illustrates a partially exploded perspective view of an example pole and housing assembly, according to an embodiment.

FIGS. 5A and 5B illustrate a perspective view and a side view, respectively, of an example stabilizing element, according to an embodiment.

FIGS. 6A and 6B illustrate a top perspective view and a bottom perspective view, respectively, of an example housing end cap, according to an embodiment.

FIGS. 7A, 7B, 7C, and 7D illustrate a perspective view, a bottom view, a side view, and a cross-sectional side view, respectively, of an example stabilizing guide, according to an embodiment.

FIGS. 8A, 8B, 8C, and 8D illustrate a perspective view, a bottom view, a side view, and a cross-sectional side view, respectively, of an example stop element, according to an embodiment.

FIGS. 9A and 9B illustrate a top perspective view and a bottom perspective view, respectively, of an example distal end cap, according to an embodiment.

FIG. 9C illustrates a perspective view of an example shaft collar that can be used as a flag stop, according to an embodiment.

FIG. 9D illustrates a perspective view of an example flag, according to an embodiment.

FIGS. 10A and 10B illustrate a perspective view of an example coupling member when together in the clamped position and separated in the opened position, according to an embodiment.

FIGS. 10C, 10D, 10E, and 10F illustrate various views of an example universal coupling member, according to an embodiment.

FIG. 11 illustrates a perspective view of an example trim ring, according to an embodiment.

FIGS. 12A, 12B, 12C, 12D, 12E, and 12F illustrate side views of an example pole and housing assembly 101 at various stages of deployment, according to an embodiment.

FIG. 13 illustrates a flow chart of an example method for activating the flag housing and deployment system to move the flag to the housed position and the deployed position, according to an embodiment.

FIGS. 14A and 14B illustrate diagrams of an example implementation of a tilt sensor on a boat for a flag housing and deployment system, according to an embodiment.

FIG. 15 illustrates diagrams of an example implementation of a proximity sensor on a boat for a flag housing and deployment system, according to an embodiment.

FIG. 16 illustrates diagrams of an example implementation of a camera and image sensor on a boat for a flag housing and deployment system, according to an embodiment.

FIG. 17 illustrates diagrams of an example implementation of a RPM sensor on a boat for a flag housing and deployment system, according to an embodiment.

FIGS. 18A, 18B, 18C, 18D, 18E, and 18F illustrates example schematics of a RF toggle circuit, a toggle and debounce circuit, a latch relay, a momentary ground circuit, a master relay, and various connectors for a pulse delivery circuit of a control system for the flag deployment and housing system, according to an embodiment.

FIG. 19 illustrates a diagram of an example daisy-chained configuration of multiple user-input devices using category cables (e.g., CAT6 cables), according to an embodiment.

The figures depict various embodiments of the present invention for purposes of illustration only, wherein the figures use like reference numerals to identify like elements. One skilled in the art will readily recognize from the following discussion that alternative embodiments of the structures and methods depicted in the figures may be employed without departing from the principles of the invention described herein.

### DETAILED DESCRIPTION OF THE INVENTION

Before the present invention is described in great detail, it is to be understood that this invention is not limited to particular embodiments described, as such can, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges can independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

As will be apparent to those of skill in the art upon reading this disclosure, each of the individual embodiments described and depicted herein has discrete components and features which can be readily separated from or combined with the features of any of the other several embodiments without departing from the scope or spirit of the present invention. Any recited method can be carried out in the order of events recited or in any other order that is logically possible.

In one aspect of the present disclosure, flag housing and deployment systems are provided that enables a flag to be deployed from, and housed within, a housing. The flag housing and deployment systems include a pole and housing assembly and an actuation system. The pole and housing assembly can include a housing and an elongated member disposed within the housing. A flag can be coupled near the end of the elongated member such that it can be moved in and out of an open end of the housing. In one embodiment, the pole and housing assembly includes one or more coupling members, such as clamps, screws and bolts, latches, straps, ball and joint fasteners, or any other suitable coupling (or fastening) device, to couple the pole and housing assembly to a structure on a boat (or other vehicle, vessel, etc.) for instance. In another embodiment, the pole and housing assembly is integrated within the structure (e.g., tower or frame) of the boat, such as by implementing the tower of the boat as the housing of the pole and housing assembly. It should be appreciated that the flag housing and deployment systems and methods described herein can also be applicable to a wide variety of applications, such as boating; towed water sport, include water skiing, wakeboarding, wakesurfing, hydrofoiling, kneeboarding, tubing, and skurfing, etc.; and, other suitable application where people would be manually raising and lowering a flag.

The actuation system is operatively coupled to the pole and housing assembly and controls the deployment and housing of the flag based upon the occurrences of triggering events. The actuation system includes an energy source to provide the energy to move the elongated member to deploy and house the flag. Different energy sources, such as compressors and motors, can be implemented in various embodiments to provide pneumatic pressure, hydraulic pressure, or electrical current to move the elongated member to deploy and house the flag. The actuation system also includes a control system having a processor that activates the deployment and housing of the flag based on input data (e.g., sensor data) from one or more input devices. The input devices can include, for instance, a user control device (e.g., button, keypad, touchpad, microphone for voice activation, smartphone or tablet, etc.) that allows a user to initiate the deployment and housing of the flag; and/or one or more sensors, such as image sensors, proximity sensors, tilt sensors (or attitude sensors, inclinometers, etc.), revolutions per minute (RPM) sensors, global positioning systems (GPS) sensor, speed sensor, accelerometer, etc.

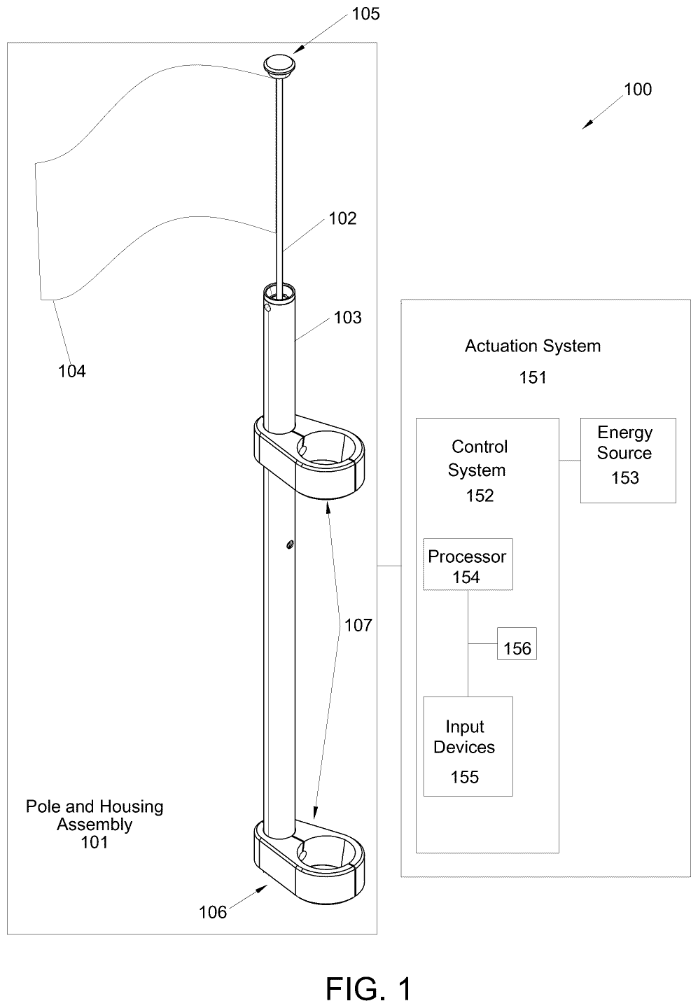

FIG. 1 illustrates a functional block diagram of an example flag housing and deployment system, according to an embodiment. In FIG. 1, a flag housing and deployment system 100 is shown including a pole and housing assembly 101 and an actuation system 151. The pole and housing assembly 101 is shown including an elongated member 102 disposed within a hollow interior of a housing 103. The elongated member 102 can vary in cross-sectional shape in different implementations. In the preferred embodiment, the elongated member 102 has a circular cross-section. To facilitate understanding, references to the term “distal” (e.g., distal end, distal side, etc.) are used herein with respect to the pole and housing assembly 101 (or to components therein) and refer generally to an end (or side) 105 of the pole and housing assembly 101 (or of the components therein) in which the flag deploys. Further, references to the terms “proximal” (e.g., proximal end, proximal side, etc.) are used herein with respect to the pole and housing assembly 101 (or to components therein) and refer generally to the end (or side) 106 of the pole and housing assembly 101 (or of the components therein) that is opposite the end 105. The elongated member 102 and the housing 103 are example components that may be referenced with respect to the terms distal, distally, proximal, proximally, etc. Similarly, references to the terms “distally” (e.g., move distally, etc.) and “proximally” (e.g., move proximally, etc.) are used herein with respect to the pole and housing assembly 101 (or to components therein) and refer generally to a direction towards the end 105 and a direction towards the end 106, respectively. These references are applicable to other figures as well and not just to FIG. 1.

A flag 104 is coupled to the elongated member 102 near a distal end of the elongated member 102. The elongated member 102 is movable within the housing 103 between a first position and a second position. In the first position (also referred to herein as a “housed position”, the elongated member 102 is disposed within the housing 103 such that the elongated member 102 is moved all the way proximally and the flag 104 is fully housed within the housing 103. The elongated member 102 can move within the housing 103 to the second position where the elongated member is moved all the way distally so as to extend out of the distal end of the housing 103 with the flag 104 completely out of the housing 103 (also referred to herein as a “deployed position”), such as shown in FIG. 1. References to the terms “deployed position” and “housed position” may be used herein with respect to the pole and housing assembly 101 (or to the components therein) and should be understood to refer to the position of the pole and housing assembly 101 (or position of the components therein) when in the respective deployed and housed positions. Similarly, references to the pole and housing assembly 101 (or position of the components therein) being deployed or being housed may be used herein and refer generally to the pole and housing assembly 101 (or the components therein) being moved to the deployed position or the housed position, respectively.

The pole and housing assembly 101 can include one or more coupling members 107 for coupling the housing 103 to a structure on a boat (or other vehicle, vessel, etc.). In FIG. 1, the pole and housing assembly 101 includes two coupling members 107 that can secure to a structure on the boat, such as around the tower or frame of the boat. Any suitable mechanism for the coupling member 107 can be used in different embodiments to secure the housing 103 to a structure on the boat, such as clamps, latches, hook and latch (e.g., Velcro) straps, ball and joint, etc. In a preferred embodiment, the coupling member 107 is configured to clamp to the housing 103 and to the structure on the boat.

The actuation system 151 is shown including a control system 152 and an energy source 153. The energy source 153 provides the energy to move the elongated member 102 to the housed and deployed positions. The actuation system 151 is configured to “automatically move” the elongated member 102 to the housed and deployed positions based on the occurrence of a triggering event. The phrase “automatically move” is used herein to mean that the actuation system 151 provides the energy and force to move the elongated member 102 to the housed position and to the deployed position upon the occurrence of the triggering event. The movement of the elongated member 102 by the actuation system 151 is “automatic” and in contrast to manual force provided by a user to move the elongated member to the housed position or to the deployed position. While in the present disclosure, user input can indicate an occurrence of a triggering event (e.g., initiate or trigger the movement of the elongated member 102, such as by the pressing of a button by the user), the actual force to move (or “automatically move”) the elongated member 102 is provided by the energy from the energy source 153—not the manual force of the user. Manual force of the user is not required to move the flag to the deployed position or to the housed position. Furthermore, it is noted that the pressing of the button by the user is not a manual force that generates stored energy. Thus, it is different and distinct from a user-applied force that generates stored energy, such as the manual compression of a spring by a user. Different energy sources, such as compressors and motors, can be implemented in various embodiments to provide pneumatic pressure, hydraulic pressure, or electrical current to move the elongated member 102. Therefore, it should be appreciated that references herein to the elongated member 102 being “moved” by the actuation system 151 are intended to mean that the elongated member 102 is being “automatically moved” by the actuation system 151 even though not explicitly stating so.

The control system 152 is operationally coupled to the energy source and controls when the energy source 153, or energy derived from the energy source 153, is utilized to automatically move the elongated member 102 to the housed and deployed positions. The control system 152 includes a processor 154 that can be programmed to control the energy source 153 to automatically move the elongated member 102 to the housed and deployed positions based on the occurrence of the corresponding triggering events. The term “processor” is used broadly herein and may refer to one or more processing devices, processing circuitry, embedded or non-embedded cores, etc., and may include controllers, microprocessors, microcontrollers, field programmable gate arrays (FPGAs), application specific integrated circuits (ASICs), etc.

The control system 152 can also include one or more input devices 155 that provide input (e.g., information, data, electrical signals, etc.) that can be used to determine when a triggering event has occurred. The input device 155 can be configured to communicate wired or wirelessly with the processor 154, such as with Bluetooth or other suitable wireless technology. The input device 155 can be a user control device (e.g., a button, switch, fob, smartphone, tablet, etc.), one or more sensors, or combination thereof, that can be used to trigger the actuation system 151 to automatically move the elongated member 102 to the housed and deployed position. The input device 155 can be a device located locally to the control system 152 (e.g., a button electrically coupled to the circuit board with the processor) or remotely, such as a remotely located button or switch, a remote control fob, remote sensor, smartphone, tablet, etc., that may be located in a different location on the boat or held by the user. Example sensors can include image sensors, proximity sensors, tilt sensors, revolutions per minute (RPM) sensors, global positioning systems (GPS) sensors, speed sensors, accelerometer sensors, etc. The image sensor can be used in conjunction with a camera to provide various images. The term “images” is used broadly herein and may refer to an image of a picture or video images (e.g., a series of images). The term “tilt sensor” is used broadly herein to refer to any sensor that can be used to determine the tilt or angle of a boat with respect to the water, and may include other related devices such as attitude sensors, inclinometers, etc.

In one embodiment, the control system 152 can be configured to provide a state indicator on one or more input devices. The state indicator tracks and indicates the current state of position of the flag (e.g., deployed or housed), such as by a light source, LED, display, icon, symbol, text, etc. The input device can be any suitable device that can provide the indication, such as a stand-alone light source (e.g., LED), a user-input device (e.g., remote push button, remote FOB, etc.) with a light source or LED integrated, a device having a graphical user interface such as a graphical display, touchscreen, etc. The device can be, for instance, a smartphone, stand-alone display for mounting on the dashboard of the boat, a display integrated into equipment or dashboard of the boat, etc. The current state of position can be indicated by the activation of light source or LED; a color of the light source or LED; a flashing of the light source or LED; a display of an icon, symbol or text; or a combination thereof. In one embodiment, the state indicator can also be configured to indicate that the flag is in the process of changing states of position. The state indicate can be configured to indicate the state of position of the flag when the flag is deployed and housed using one or more input devices, or when one or more sensors are used to deploy or house the flag.

The state indicator can be implemented in a stand-alone device—e.g., a LED or display—or can be incorporated within the user control device. For example, a remote button may be configured to include an LED that illuminates (or changes colors, flashes, etc.) as programmed when the flag is raised, lowered, in the process or being raised or lowered, etc. For example, a user control device can be configured to display one color when the flag is in the housed position, and another color when the flag is in the deployed position. The indication of the current state of position can alternatively be an icon, symbol, or text that is displayed or illuminated; or, can optionally be used in conjunction with the feature of changing color. Suitable icons, symbols, and text may vary but preferred to convey an intuitive understanding associated with whether the flag is deployed or housed. For instance, example symbols and text may include, but are not limited to, a flag symbol with and without an “X” through it to indicate being deployed and housed, respectively; the word “deployed” and “housed” (or “raised” and “lowered”, “up” and “down”, etc.) to indicate being deployed and housed, respectively; a “1” or “0” to indicate being deployed and housed, respectively; etc. In one embodiment, the indication of current state of position can be indicated by the flashing of a color, icon, symbol, or text. In another embodiment, flashing can be used as an indicator that the flag is in the process of changing states of position—i.e., the indicator flashes while the flag is moving to the deployed position, or moving to the housed position. For example, the color, symbol, or text, can be used to indicate the current state of position, but when transitioning to either the deployed or housed position, the color, symbol, or text may flash to indicate its changing status. It should be appreciated that the indication of state of position (or changing state of position) can also be applicable to one or more sensors. For instance, the actuation system can include an input device (e.g., LED or display) that indicates the state of position (or changing state of position) of the flag in response to triggering events by the one or more sensors. The LED or display can be implemented and positioned in a visible location, and/or implemented in the user control device to operate in conjunction with triggering events by the user control device. It should be appreciated that the state indicator can be programmed in any suitable manner, such as with a analog circuit, a digital or programmable chip, microprocessor or microcontroller, etc.

It should be appreciated that the control system 152 can also include additional electrical and mechanical components 156 necessary to utilize the energy source 153, such as switches, valves, hoses, etc. For the sake of brevity and clarity, not all electrical and mechanical components 156 are described in depth herein as they are well understood in the art.

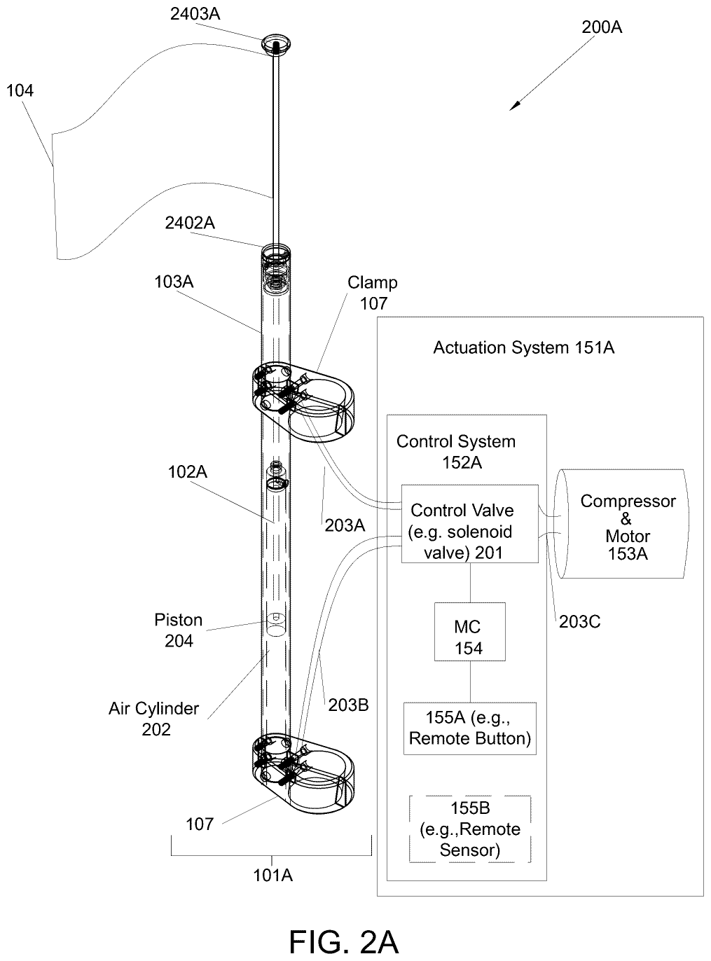

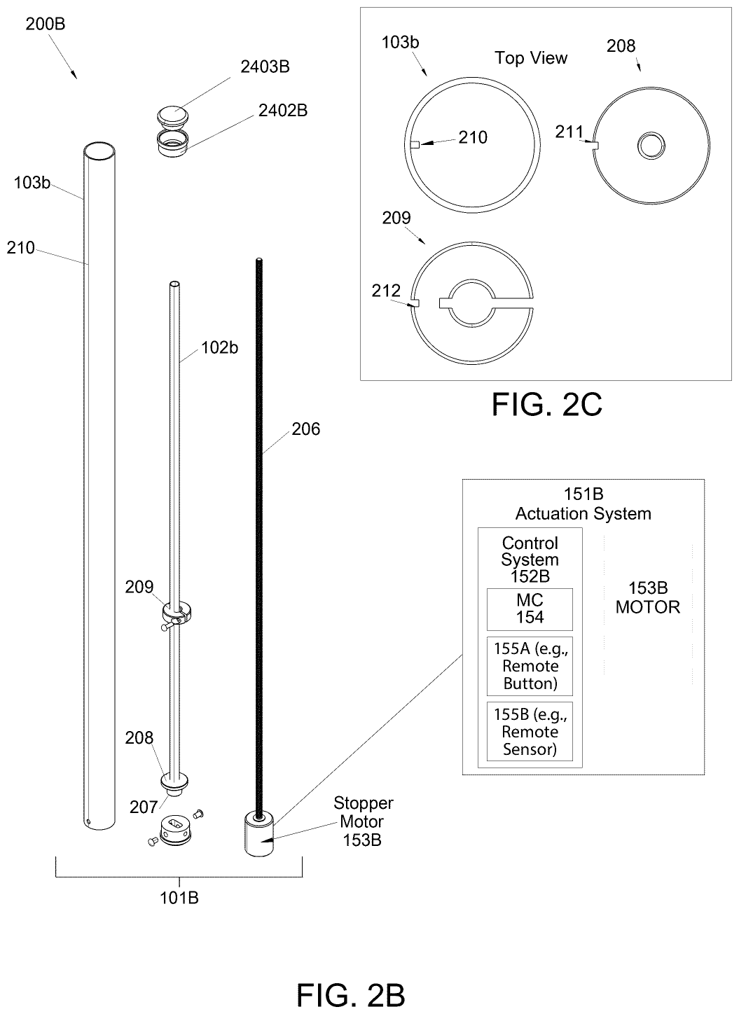

FIGS. 2A and 2B illustrate diagrams of example flag housing and deployment systems with different example actuation systems, according to some embodiments. As FIGS. 2A and 2B have similar components, the two figures are described simultaneously with differences noted and described. To facilitate explanation of FIGS. 2A and 2B, many reference numbers for various components have been distinguished with reference numerals having the letters “a” or “b”. It should be appreciated, however, that the general discussion of similar components in figures other than FIGS. 2A and 2B may also still apply to the components distinguished with an “a” or “b” in FIGS. 2A and 2B, such as example specifications, materials, etc. In FIGS. 2A and 2B, the flag housing and deployment systems 200A and 200B are shown including the pole and housing assemblies 101A,101B and actuation systems 151A,151B, respectively. In FIGS. 2A and 2B, the control systems 152A and 152B are shown including a processor 154 (e.g., microcontroller) and one or more input devices 155 (e.g., a remotely located button, switch, fob, or combination thereof) that can control the housing and deployment of the flag 104. For example, the user control device (e.g., remote button) 155A can be integrated within the boat paneling, located on the actuation system housing, located on a handheld fob, integrated within an app on a mobile device or tablet, etc. It should be appreciated that any of the variety of input devices 155, or combination thereof, can be implemented as the one or more input devices. In FIGS. 2A and 2B, two example input devices 155 are shown as a remote button 155A and a remote sensor 155B, such as an image sensor, proximity sensor, tilt sensor, RPM sensor, GPS sensor, speed sensor, accelerometer sensor, or any combination thereof. It should be appreciated that other variations and combinations of input devices can be implemented. It should be appreciated that a remote button can include devices that have a mechanical button as well as devices that may include a button displayed on a graphical user interface, touchscreen, etc.

In FIG. 2A, the actuation system 151A uses pneumatic actuation and includes a compressor and motor 153A as the energy source. Further, the additional electrical and mechanical components 156 of the control system 152A also include: 1) a control valve 201 (e.g., a solenoid valve or other suitable valve) that is communicatively coupled to the processor 154 and operationally coupled to the compressor and motor 153A; and 2) an air cylinder 202 that is disposed within the housing 103A; and, 3) hoses 203a and 203b between the control valve and the air cylinder 202, as well as a hose 203c between the control valve and the compressor. The hoses 203a and 203b are coupled to the air cylinder 202 on opposite sides of a piston 204 to move the piston 204 proximally or distally depending on which hoses 203a and 203b air is entering and leaving. The processor 154 can be programmed to control the control valve 201 to enable the flow of air to move the piston 204 distally or proximally. The piston 204 is coupled to a proximal end of the elongated member 102A so as to enable movement of the elongated member 102A to the housed or deployed positions based on air pressure. In an embodiment, the hoses 203a and 203b are coupled to the air cylinder 202 through holes in the respective coupling members 107, which are configured to clamp or otherwise secure to a structure on a boat (e.g., tower or other suitable hollow frame). In this way, the hoses 203a and 203b can be ran through the interior of the structure on the boat so as to be hidden, out of the way, and to avoid being exposed to the elements.

In FIG. 2B, flag housing and deployment systems 200B uses a linear actuator including a nut 207, screw 206, and electrical motor 153B (i.e., the energy source). The nut 207 is configured to be moved along the screw 206 as the screw 206 is rotated by the electrical motor 153B. The nut 207 can move in both directions along the screw 206 depending on the rotational direction of the screw 206. The pole and housing assembly 101B is shown in an exploded view and includes a housing 103B, an elongated member 102B, the screw 206, the nut 207, and the motor 153B. The elongated member 102B, the screw 206, the nut 207, and the motor 153B are all disposed within the housing 103B during operation. The motor 153B is coupled to the proximal end of the screw 206 and configured to rotate the screw 206 in both directions. The motor 153B can be, for example, a stepper motor or any other suitable AC or DC motor that rotates the screw 206 in either direction to move the nut 207 and elongated member 102B in corresponding directions within the housing 103B to deploy and house the flag. The proximal end of the elongated member 102B is coupled to the nut 207 such that the elongated member 102B can move with the nut 207 as the nut 207 moves along the screw 206.

The term “linear actuator” is used broadly herein to refer generally to any mechanical device that converts rotational motion into linear motion to move objects in a straight line, such as typically with an electric motor and a lead, ball, or roller screw that translates the motor's rotary motion into linear motion. It should be appreciated that in other embodiments, the linear actuator can utilize a different mechanism than the ball nut and ball screw to move a traveling member (e.g., the nut 207 shown in FIG. 2B) longitudinally within the interior of the housing 103B. For example, the linear actuators can include a screw and nut, belt and pulley drive, chain drive, a direct drive, hydraulic drive, rack and pinion drive, or other suitable drive, that can move the traveling member linearly. Furthermore, it should be appreciated that different types of motors can be implemented in various embodiments, such as stepper motors, servo motors, DC motor, hydraulic motor or any other suitable motor.

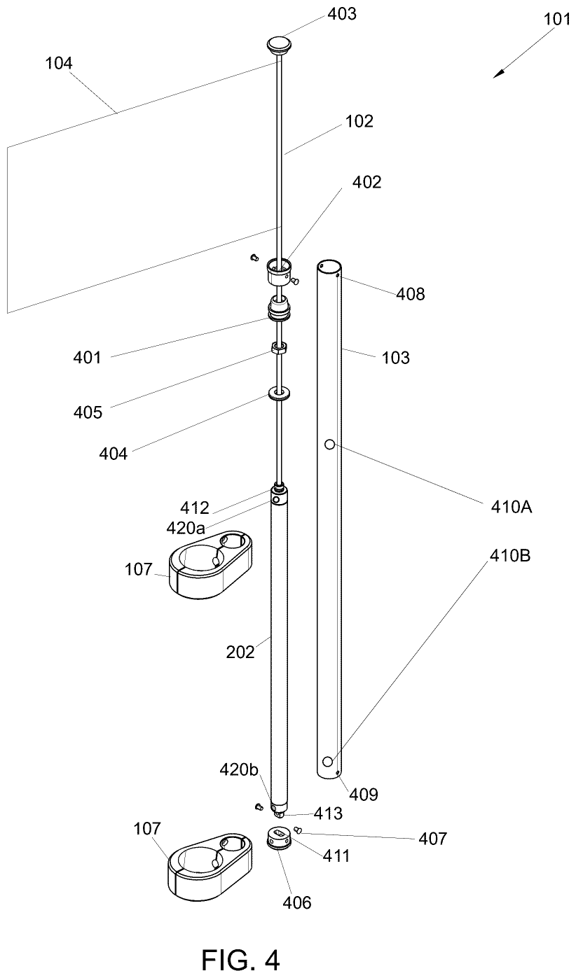

The nut 207 is configured to couple to, or otherwise be fixed to, the proximal end of the elongated member 102B. The nut 207 and the screw 206 are threaded and configured such that the nut 207 can screw onto the screw 206. A stabilizing element 208 is coupled or otherwise fixed to (e.g., welded to) nut 207 and the proximal end of the elongated member 102B. A stabilizing element 209 is also coupled to or otherwise fixed to the elongated member 102B in between the proximal and distal ends of the elongated member 102B. The stabilizing elements 208,209 can be approximately shaped and sized to correspond to the interior cross-section of the housing 103B to serve to stabilize the elongated member 102 within the housing 103B. The position of the stabilizing element 209 along the elongated member 102B can vary as desired. In a preferred, embodiment, the stabilizing element 209 is positioned along the elongated member 102B such that it is positioned at the distal end of the housing 103B when in the deployed position to maximize the stability of the elongated member 102B when deployed. The stabilizing element 209 can be configured to contact (or abut) a stop element 2402B (e.g., similar to the stop element 402 further discussed in FIG. 4) at the distal end of the housing 103B to increase stability. An end cap 2403B can be coupled to the distal end of the elongated member 102B and serve to close off the open distal end of the housing 103B when the flag is housed. Similarly, a stop element 2402A and end cap 2403A are included within the system 200A in FIG. 2A.

FIG. 2C illustrates close-up top views of each of the housing 103B, the stabilizing element 208, and the stabilizing element 209 shown in the exploded diagram of FIG. 2B to facilitate understanding. The housing 103B includes a rail 210 that extends longitudinally within the interior of the housing 103B from the proximal end to the distal end. The stabilizing elements 208,209 include respective slots 211,212 that are configured to fit on the rail 210. In this way, the stabilizing elements 208,209 can move linearly along the rail 210 but cannot rotate because of the rail 210. Because the nut 207 is disposed on the screw 206 but fixed to the stabilizing element 208 and elongated member 102B, the rotation of the screw 206 does not rotate the nut but instead moves the nut 207 along the screw 206, which thereby moves the stabilizing element 208 and the elongated member 102B linearly either distally or proximally depending on the direction of rotation of the screw 206. The movement of the elongated member 102B also moves the stabilizing element 209.

It should be appreciated that one or more the components and associated functions of the actuation system 151 (e.g., 151A or 151B) can be implemented within or on the pole and housing assembly 101, such as with the air cylinder 202 within in the housing 103A in FIG. 2A, or with the motor 153B, screw 206, and the nut 207 within the housing 103B in FIG. 2B. Since the motor 153B is disposed within the housing 103B, it is referred to herein as part of the pole and housing 101B; however, functionally it can be viewed as part of the actuation system 151B and thus also shown dotted in the actuation system 151B in FIG. 2B. Similarly, the screw 206 and the nut 207 can be viewed functionally as part of the control system 152B, such as part of the additional electrical and mechanical components 156 described in FIG. 1.

In FIGS. 2A and 2B, the control systems 152A and 152B also include a sensor, such as one or more of the sensors described for FIG. 1. For instance, the sensor 155B can include an RPM sensor, tilt sensor, proximity sensor, image sensor (and camera), GPS sensor, speed sensor, accelerometer sensor, or combination thereof, that detects the respective RPM of the boat, the tilt of the boat, the proximity of the participant behind the boat, and the position or location of the participant behind the boat (e.g., via image sensor), a speed or acceleration of the boat (e.g., via GPS sensor, speed sensor, accelerometer sensor, etc.). The sensors send the sensor data to the processor 154 (e.g., microcontroller). The processor 154 receives the sensor data to determine whether an occurrence of a triggering event has occurred. When a triggering event is detected, the actuation system 151A, 151B is activated to move the elongated member 102A,102B to the housed or deployed position. Example triggering events that can trigger movement to the deployed or housed positions can be based on or related to, but not limited to, a threshold RPM value of the boat (e.g., via an RPM sensor), a tilt of the boat (e.g., via a tilt sensor), a threshold proximity of the participant behind the boat (e.g., via a proximity sensor), position or location of a person behind the boat (e.g., via an image sensor and camera), the depression of a corresponding button on a local or remote device, such as a fob, smartphone, tablet, etc. (e.g., via receiver or transceiver in communication with the local or remote device) for housing the flag, or combination thereof. The occurrence of triggering events can, for example, represent that the boat is moving above or below a threshold and thus successfully towing a participant (e.g., a skier, wake boarder, etc.), or represent that the boat has slowed below a threshold (or stopped) because a participant has fallen in the water or is in the water.

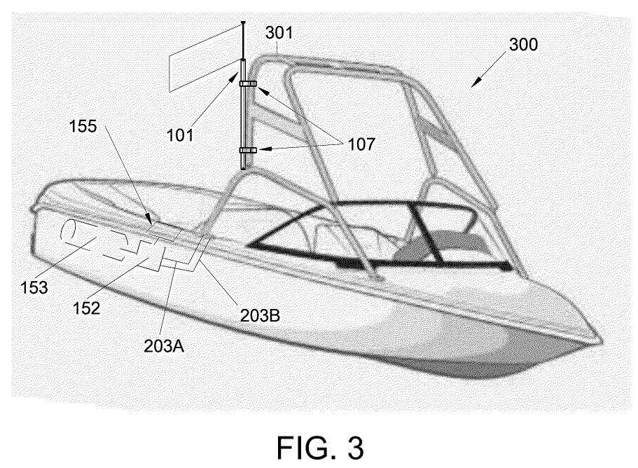

FIG. 3 illustrates a diagram of an example flag housing and deployment system coupled to a boat, according to an embodiment. In FIG. 3, a boat 300 is shown with the flag housing and deployment system 100 installed. The pole and housing assembly 101 is coupled to a structure (e.g., tower or frame) 301 of the boat 300 via the coupling members 107. Some or all of the actuation system 151 can be partially or fully disposed within the interior (e.g., paneling, shell, hull, etc.) of the boat. For example, the control system 152 and the energy source 153 can be disposed within the paneling with the input device 155 integrated into the paneling to expose a button or switch for instance. With the flag housing and deployment system 200A, the hoses 203a and 203b can be run from the control system 152A (e.g., from the control valve 201 of the control system 152A), within and up the structure (e.g., frame) 301, and through holes within the coupling members 107, so that it remains concealed and unexposed to the elements. It should be appreciated that the placement of the components of the pole and housing assembly 101 and the actuation system 151 are example to facilitate understanding and can vary in different implementations as desired. Further, one or more input devices (e.g., sensors) can be implemented and positioned in the appropriate locations as needed or desired.

FIG. 4 illustrates a partially exploded perspective view of an example pole and housing assembly, according to an embodiment. In FIG. 4, the pole and housing assembly 101 is shown including the elongated member 102, the housing 103, the flag 104, the coupling members 107, and the air cylinder 202 with the piston 204 (not shown in FIG. 4). The pole and housing assembly 101 is also shown including a stabilizing guide 401, a stop element 402, a distal end cap 403, a stabilizing element 404, a nut 405, housing end cap 406, screws 407, a mating element 413 on the air cylinder 202, and corresponding mating element 411 on the housing end cap 406. The mating elements 411,413 serve to secure the air cylinder within the housing 103 and may include any type of suitable connection mechanism. In one implementation, the mating element 413 is a metal pin that extends from the proximal end of the air cylinder 202, while the mating element 411 is a groove or slot shaped to receive the metal pin and prevent the metal pin and air cylinder 202 from turning. Screws can also be implemented with the metal pin and groove to further secure the metal pin within the groove. In other implementations, the mating elements can be a respective screw and hole, bolt and nut, clamp, latch, or any other suitable mechanism to secure the air cylinder 202 to the end cap 406 and housing 103 and to prevent it from turning.

The housing 103 can be a hollow tube, for instance, that extends from a proximal end to a distal end. In FIG. 4, the distal end of the housing 103 is referred to herein as the end that the flag 104 enters and exits the hollow interior of the housing 103. The proximal end of the housing 103 is referred to herein as the end opposite of the distal end and can be coupled to or contain a portion of the actuation system, such as the air cylinder 202 (e.g., in FIG. 2A) or the motor 153B in FIG. 2B. The size and shape of the housing 103 can vary in different embodiments. Example cross-sectional shapes of the elongated member can include, but are not limited to, a circle, oval, square, polygon, or other regular or irregular geometric shape. In a preferred embodiment, the cross-sectional shape is a circle. Example cross-sectional sizes (e.g., diameters or widths) of the housing 103 can include, but are not limited to, cross-sectional sizes ranging between ½ in. (inch) and 3 in., such as cross-sectional sizes ranging between 1 in. and 2 in. In one embodiment, the cross-sectional size of the housing 103 is approximately 1.6 in. It should be appreciated that the housing 103 can have cross-sectional shapes and sizes outside of these example ranges in other embodiments without compromising the underlying principles of the present disclosure.

In one embodiment, the elongated housing 103 is integrated in the structure (e.g., tower or frame) 301 of the boat 300 such that the housing 103 is positioned within the structure (e.g., within the hollow of the tower or frame), or such that the structure is (or serves as) the housing 103 itself. For example, boat manufacturers may integrate the flag housing and deployment system within the housing 103 (e.g., positioned within the hollow of the tower or frame of a boat, or such that the tower or frame of the boat serves as the housing 103) to sell as a built-in feature of the boat. It should be appreciated that in such embodiment the coupling members 107 may not be implemented as they are not necessary since the housing 103 is the part of the tower. The integrated embodiment can result in various advantages, such as reduction in parts, lower cost to manufacture, better concealment for better protection and aesthetics, additional selling features for boat manufacturers, improved placement on the boat, etc.

The length of the housing 103 can vary in different embodiments. The length of the housing 103 can vary depending on the length of the elongated member 102 and the actuation system implemented. The length of the housing 103 should be long enough to enable the actuation system to move the flag 104 to a sufficient or desired height out of the housing 103 when in the deployed position, but also adequately house the flag 104 within the housing 103 when in the housed position. Example lengths of the housing 103 can include, but are not limited to, lengths ranging between 24 in. and 84 in., such as lengths ranging between 36 in. and 48 in. In one embodiment, the length of the housing 103 is approximately 42.5 in. It should be appreciated that the housing 103 can have lengths outside of these example ranges in other embodiments. For example, yachts and other large vessels may have flag tubes or housings that are 20 feet high, such as to fly flags representing countries or other desired purpose. It should be appreciated that the flag housing and deployment system 100 and components therein, which are described herein and provided with example sizes (or specifications), can be scaled up or down as necessary beyond the example sizes to accommodate smaller or larger designs as desired, such as with the example application in the yacht.

The housing 103 can include various holes that serve various functions. For example, the housing 103 is shown including a pair of holes 409 on opposite sides at the proximal end and another pair of holes 408 on opposite sides at the distal end of the housing 103. These holes 408,409 can be used with screws to secure the housing to another part of the assembly 101, such as to the stop element 402 and to the housing end cap 406, respectively. The housing 103 is also shown including holes 410a and 410b, through which hoses 203a and 203b (not shown in FIG. 4 but shown in FIG. 2A) are inserted to enable air to enter or exit the air cylinder 202 via air fittings to move the piston 204, which is configured to couple to the elongated member 102. The 410b is located on the proximal end of the housing 103 and on one side of the piston 204, while the other hole 410a is located toward the distal end of the housing 103 and on the other side of the piston 204. In this way, air can enter through the hose 203a via hole 410A and exit through the hose 203b via hole 410B to push the piston 204 one direction (i.e., toward the proximal end of the housing 103) to house the flag 104, and vice versa to push the piston 204 the other direction (i.e., toward the distal end of the housing 103) to deploy the flag 104.

In an embodiment, the elongated member 102 can be a rod or pole that extends from a proximal end to a distal end. In FIG. 4, the flag 104 is coupled to the distal end of the elongated member 102, and the proximal end of the elongated member 102 is coupled to piston 204 in the air cylinder 202. The size and shape of the elongated member 102 can vary in different embodiments. Example cross-sectional shapes of the elongated member can include, but are not limited to, a circle, oval, square, polygon, or other regular or irregular geometric shape. In a preferred embodiment, the cross-sectional shape is a circle. Example cross-sectional sizes (e.g., diameters or widths) of the elongated member 102 can include, but are not limited to, cross-sectional sizes ranging between ⅛ in. (inch) and 1 in., such as cross-sectional sizes ranging between ¼ in. and ½ in. In one embodiment, the cross-sectional size of the elongated member 102 is approximately 5/16 in. It should be appreciated that the elongated member 102 can have cross-sectional shapes and sizes outside of these example ranges in other embodiments.

The length of the elongated member 102 can vary in different embodiments. The length of the elongated member 102 can vary depending on the length of the housing 103 and the actuation system implemented. The length of the elongated member 102 should be long enough to raise the flag 104 to a sufficient height out of the housing 103 when in the deployed position, but also adequately house the flag 104 within the housing 103 when in the housed position. Example lengths of the elongated member can include, but are not limited to, lengths ranging between 12 in. and 48 in., such as lengths ranging between 24 in. and 36 in. It should be appreciated that the elongated member can have lengths outside of these example ranges in other embodiments.

The housing 103 and the elongated member 102 can be made from any suitable material including, but not limited to, one or more metals, metal alloys, polymers, or combination thereof. For example, in one embodiment, elongated member 102 can be made from aluminum, steel, or alloy thereof. In another embodiment, a high strength industrial plastic can be used.

The air cylinder 202 includes the piston 204 (not shown) and the elongated member 102 can be coupled to the piston 204 and function as a connecting rod or shaft. As an example assembly or manufacture, the elongated member 102 can be screwed to, or otherwise connected to, the piston or to a piston rod, or can be formed or integrated as part of the piston. In this way, when the piston 204 is moved in either direction within the air cylinder 202, the elongated member 102 is also moved in the same linear direction. The elongated member 102 extends out of a hole at the distal end of the air cylinder 202. The air cylinder 202 can include a threaded protrusion 412 around the hole at the distal end of the air cylinder 202 to function similar to a threaded bolt. The air cylinder 202 also includes ports 420a and 420b, each on an opposite side of the piston 204. The port 420a is shown near the distal end of the air cylinder 202 and port 420b near the proximal end of the air cylinder 202. The ports 420a and 420b can be threaded to receive and couple to threaded air fitting, which can be coupled to the hoses 203a and 203b from the control valve 201.

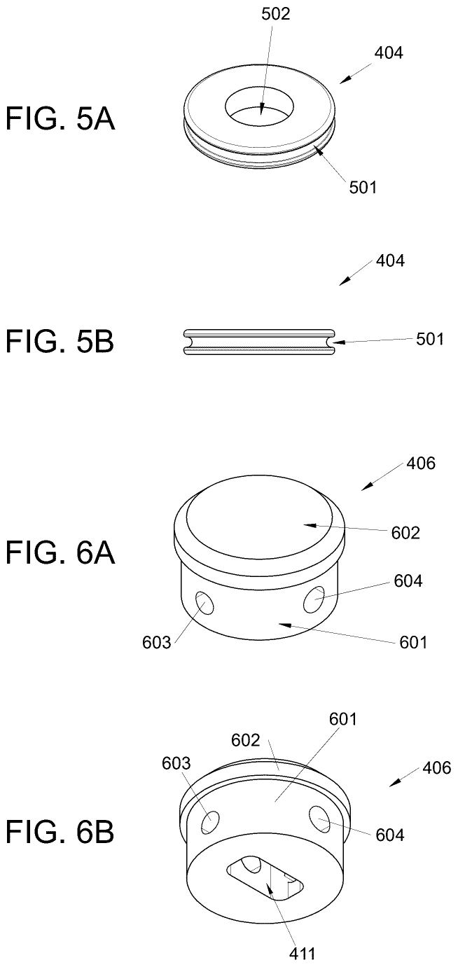

The stabilizing element 404 can then be coupled to the threaded protrusion to stabilize the housing and the air cylinder, which can also serve to stabilize the elongated member 102 at that location. FIGS. 5A and 5B illustrate a perspective view and a side view, respectively, of an example stabilizing element, according to an embodiment. In FIGS. 5A and 5B, the stabilizing element 404 is a flat cylindrical ring having a grooved outer perimeter 501 and a hole 502. In one implementation, a rubber O-ring (not shown) can be positioned around the stabilizing element 404 and sit within the grooved outer perimeter 501 to help cushion the stabilizing element 404 to the housing 103.

During the assembly, the distal end of the elongated member 102 can be inserted through the hole 502 of the stabilizing element 404. The hole 502 can be sized to fit on the threaded protrusion 412 at the distal end of the air cylinder 202. A threaded nut 405 can then be placed around the elongated member 102 and screwed on the threaded protrusion 412 to secure the stabilizing element 404 onto the distal end of the air cylinder 202.

Returning to FIG. 4, the housing end cap 406 can be coupled to the proximal end of the air cylinder 202 and enables the proximal end of the air cylinder 202 to be secured to the proximal end of the housing 103 and to serve as a cap for the housing. FIGS. 6A and 6B illustrate a top perspective view and a bottom perspective view, respectively, of an example housing end cap, according to an embodiment. In FIGS. 6A and 6B, the housing end cap 406 includes a base portion 601 that is shaped (e.g., cylindrically) and sized for insertion into the housing 103 and a cap portion 602 that will abut the proximal end of the housing 103 to close off the hollow interior at the proximal end when assembled. The base portion 601 includes a mating element 411 and screw holes 603 on opposite sides of the base portion 601. The mating element 411 is shown as a groove or slotted hole that mates with a corresponding mating element 413 on the proximal end of the air cylinder 202, which can be rectangular tab or protrusion that is sized to fit within the mating element 411. The body portion can also include holes 604 on opposite sides that align with a hole in the mating element 413 (e.g., rectangular tab). In this way, a cylindrical rod, screw, or dowel can be inserted through the holes 604 and the hole in the mating element 413 on the air cylinder 202.

During the example assembly, the housing end cap 406 can next be inserted onto the proximal end of the air cylinder 202 with the mating element 413 inserted into the mating element 411. A cylindrical pin or dowel (not shown) can then be inserted through the holes 604 and through the hole in the tab of the mating element 413, securing the housing end cap 406 to the proximal end of the air cylinder 202. The air cylinder 202 and elongated member 102 can then be inserted within the housing 103 until the holes 409 align with the holes 603 in the housing end cap 406. The screws 407 can then be inserted through the holes 409 and screwed into the holes 603 to secure the housing to the housing end cap 406 and the air cylinder 202. The holes 410a and 410b on the housing 103 are positioned to align with the holes 420a and 420b of the air cylinder 202. Once aligned, an air fitting can be screwed into the holes 410a and 420a and another air fitting can be screwed into the holes 410b and 420b.

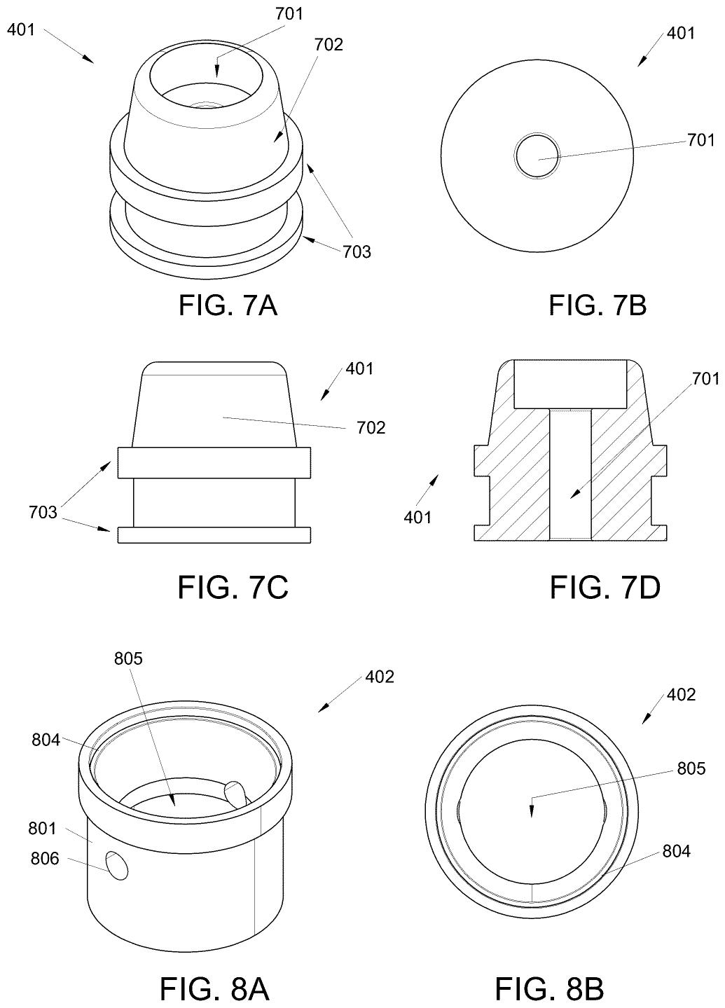

Returning to FIG. 4, the stabilizing guide 401 is disposed around the elongated member 102. In an embodiment, the flag housing and deployment system 100 includes a stabilizing guide 401 that is not fixed to the elongated member 102, but rather, can move with the elongated member 102 when little to no resistance applied against the movement of the stabilizing guide 401, and can remain fixed while the elongated member 102 slides through the stabilizing guide 401 when a threshold level of resistance is applied against the movement of the stabilizing guide 401. FIGS. 7A, 7B, 7C, and 7D illustrate a perspective view, a bottom view, a side view, and a cross-sectional side view, respectively, of an example stabilizing guide, according to an embodiment. In FIGS. 7A, 7B, 7C, and 7D, the stabilizing guide 401 is shown including a hole 701 that extends through the stabilizing guide and that is configured to receive and enable the elongated member 102 to extend through. The elongated member 102 and the hole 701 are relationally sized so as to provide a frictional fit. The hole 701 is sized and shaped so that the elongated member 102 can be disposed within the hole 701 in a stable manner with enough friction that if uninhibited, any movement of the elongated member 102 will cause the stabilizing guide 401 to move with the elongated member 102. However, the stabilizing guide 401 is not fixed to the elongated member 102 via the hole 701. The level of friction between the stabilizing guide 401 and elongated member 102 is such that if resistance is applied to the stabilizing guide 401, then the stabilizing guide 401 will stop moving with the elongated member 102 and instead enable the elongated member 102 to pass through the hole 701. In this way, for example, when the elongated member 102 moves from the housed position to the deployed position, the elongated member 102 moves with, and slides, the stabilizing guide 401 towards the distal end of the housing 103 until the stop element 402 contacts and stops the stabilizing guide 401 by applying resistance against the stabilizing guide 401. After the stop element 402 contacts and stops the stabilizing guide 401, the elongated member 102 can continue to move by sliding through the hole 701 of the stabilizing element 401 to reach the deployed position. In another embodiment, the stabilizing guide 401 can include a clamp that serves to adjust the tightness in which the stabilizing guide 401 is coupled to the elongated member 102 within the hole 701.

The stabilizing guide 401 is also shown including a contact portion 702 and a stabilizing portion 703. The stabilizing portion 703 can be shaped and sized to occupy the cross-sectional interior of the housing 103 such that it provides support to the housing 103 but also enables the stabilizing guide 401 to move within the housing 103. In the embodiment shown, stabilizing portion 703 is shaped and sized as two rings that fit the diameter of the cylindrical housing 103.

The contact portion 702 is configured to contact the stop element 402 when the elongated member 102 moves from the housed position to the deployed position. The contact portion 702 can be sized and shaped to mate with the stop element 402 to enable a more stabilized fit when together. This stabilized fit can provide added stability to the stabilizing guide 401 and the elongated member 102 at the distal end of the housing 103, which in turn can further stabilize the flag 104 and distal end of the elongated member 102 that are extended out of the housing 103 when deployed.

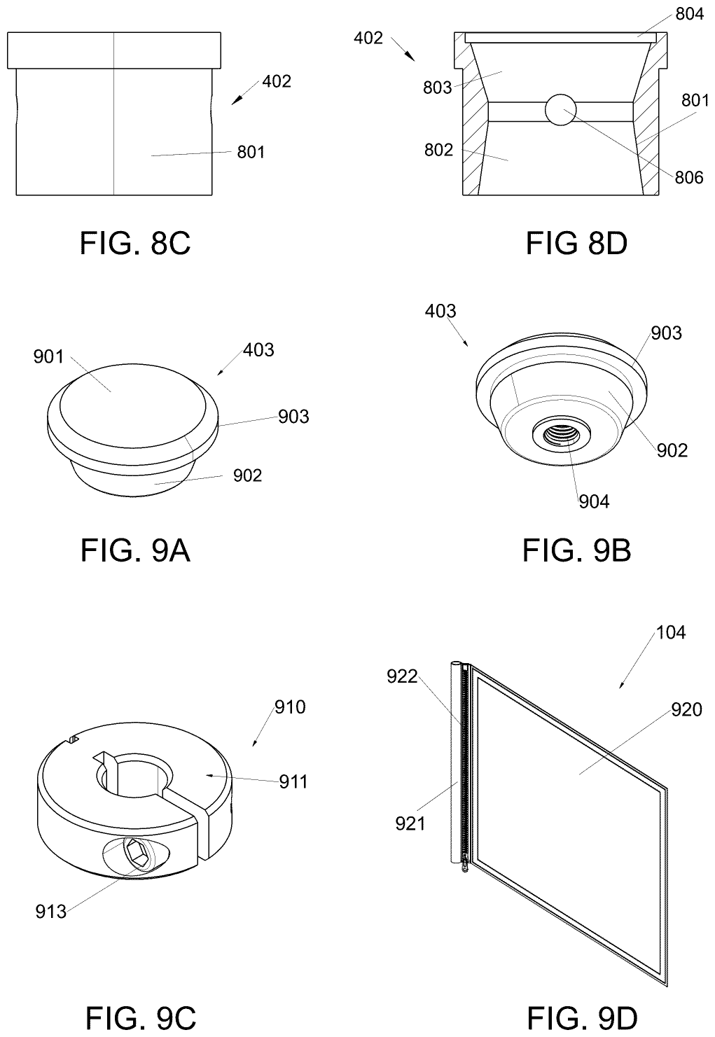

FIGS. 8A, 8B, 8C, and 8D illustrate a perspective view, a bottom view, a side view, and a cross-sectional side view, respectively, of an example stop element, according to an embodiment. In FIGS. 8A-8D, the example stop element 402 is shown including a base 801 that is shaped and sized to be disposed within the distal end of the housing 103. The base 801 can include holes 806 that enable the base 801 to be secured to the housing 103, such as with screws for instance. The base 801 is shown with cavities 802 and 803. The cavity 802 is configured to receive and stop the stabilizing guide 401 when the elongated member 102 is moving to the deployed position. For example, the cavity 802 can be shaped and sized to mate with the contact portion 702 of the stabilizing guide 703. The cavity 803 is configured to receive the distal end cap 403 on the elongated member 102 when the elongated member 102 is in the housed position. For example, the cavity 803 can be shaped and sized to mate with the distal end cap 403 to close off the distal end of the housing 103. A seal or gasket can be used and disposed on the distal end cap 403, or on a lip 804 of the stop element 402 around the cavity 803. In the embodiment shown, the base 801 includes a through-hole 805 encompassing both cavities 802 and 803.

During the assembly, the distal end of the elongated member 102 can next be extended out of the distal end of the housing 103, and the stabilizing guide 401 inserted onto the distal end of the elongated member 102. The elongated member 102 is inserted through hole 701 of the stabilizing guide 401 such that the contact portion 702 is facing towards the distal end of the elongated member 102. The elongated member 102 can then be inserted through the through-hole 805 of the stop element 402 with cavity 803 towards the distal end of the elongated member 102 and the cavity 802 towards the proximal end of the elongated member 102. The stop element 402 can then be inserted into the distal end of the housing 103, the holes 806 of the stop element 402 can be aligned with the holes 408 in the housing 103, and screws can then be screwed into the holes 408,806 to secure the stop element 402 to the distal end of the housing 103.

FIGS. 9A and 9B illustrate a top perspective view and a bottom perspective view, respectively, of an example distal end cap, according to an embodiment. In FIGS. 9A and 9B, the example distal end cap 403 is shown including a cap (or cover) 901, a body 902, a lip 903, and a threaded hole 904. The distal end of the elongated member 102 can be threaded and configured to screw within the threaded hole 904. When the distal end cap is on the distal end of the elongated member 102, the body 902 is configured to extend within the hollow interior of the housing 103 and the cavity 803 of the stop element 402. The cap 901 is configured to close off the opening of the distal end of the housing 103. For example, the cap 901 can be larger than the body 902 and the opening of the distal end of the housing 103. In this way, a lip 903 is created between the cap 901 and the body 902 that closes off the distal end of the housing 103 and the stop element 402. A seal can also be provided around the body 902 at the lip 903 to ensure a seal to protect the interior from the elements, such as water, dirt, debris, etc.

A flag stop can be used to limit the movement of the flag 104 along the elongated member 102. FIG. 9C illustrates a perspective view of an example shaft collar that can be used as a flag stop, according to an embodiment. In FIG. 9C, a shaft collar 910 is shown including a body 911 and screw 913 that can be used to clamp the shaft collar around the elongated member 102 at a desired location.

FIG. 9D illustrates a perspective view of an example flag, according to an embodiment. In FIG. 9D, the flag 104 is shown having a body 920 and a sleeve 921. The body 920 can have a wide variety of suitable shapes and sizes, such as rectangular, square, triangular, swallowtail, swallowtail and tongue, burgee, etc. In one embodiment, such as shown in the FIG. 9D, the flag has a shape of a parallelogram. The shape of the parallelogram can be beneficial by providing a smooth transition of the flag 104 in and out of the distal end of the housing 103 during deployment and housing of the flag 104. For instance, the parallelogram shaped flag can reduce the likelihood of the flag getting snagged or tangled up upon reentry into the housing 103. While a triangular flag may also provide a smooth transition in and out of the housing 103, the parallelogram shape does so while maintaining a large visible area, which increases its likelihood of being seen. Furthermore, the parallelogram shape can enable the flag to be concealed with less length required for the entire structure. The sleeve 921 can extend across the width of the flag and be sized and shaped to fit over the elongated member 102. The sleeve 921 can be beneficial to provide a more secure fit to the elongated member 102 that is less prone to wear and tear from flapping in the wind. In an embodiment, the body portion 920 and the sleeve 921 can be coupled together by a zipper or hook and latch (e.g., Velcro) connection 922 so that the body portion can be quickly and easily removable and replaced with a different flag having the compatible zipper or hook and latch connection 922.

During the example assembly, the distal end of the elongated member 102 can next be inserted through the center of the shaft collar 910, then through the sleeve 921 of the flag 104, and then screwed into the threaded hole 904 of the distal end cap 403. In an embodiment, a jam nut can be inserted onto the threaded distal end of the elongated member 102 before the distal end cap 403. The flag 104 can then be positioned at the distal end of the elongated member 102 abutting the distal end cap 403 (or the jam nut if implemented). The shaft collar 910 is then slid along the elongated member 102 and clamped so as to abut the other side of the flag 104 and secure the flag in place at the distal end of the elongated member 102. It should be appreciated that in other embodiments, instead of directly abutting the flag 104, some space can be included between the flag 104 and one or both of the shaft collar 910 and the distal end cap 403 (or jam nut if implemented).

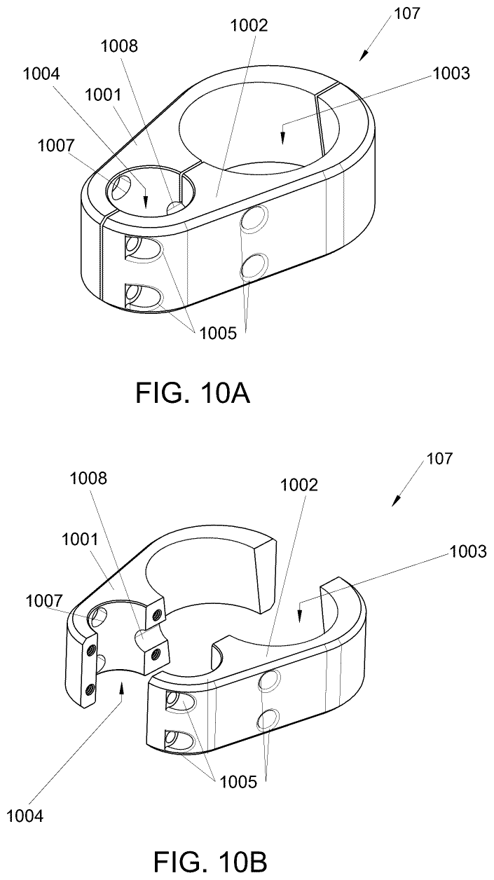

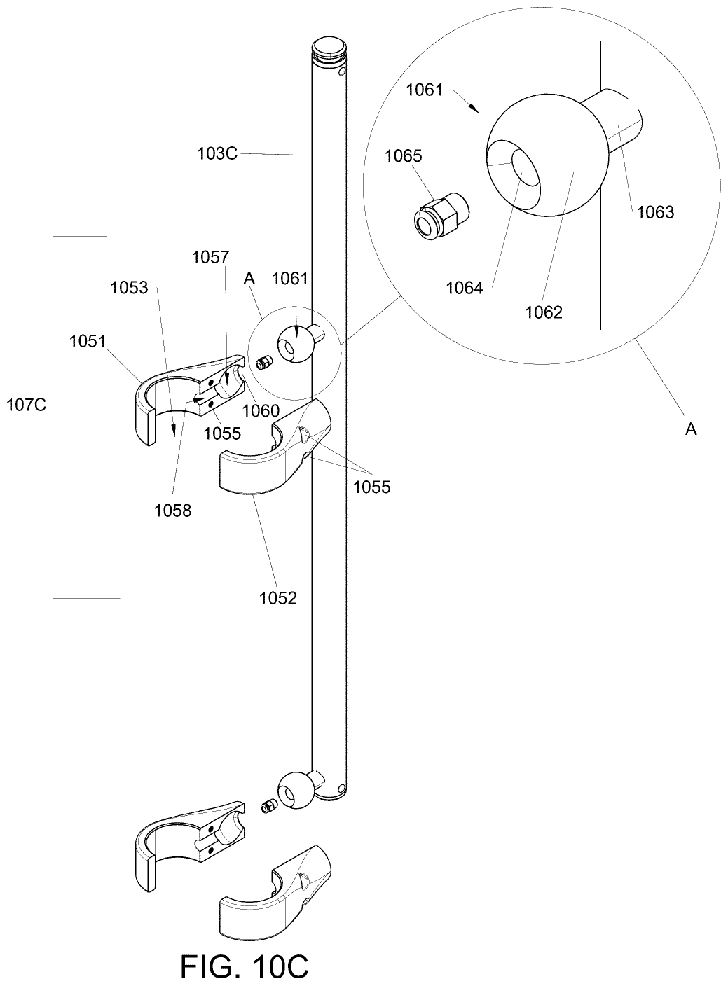

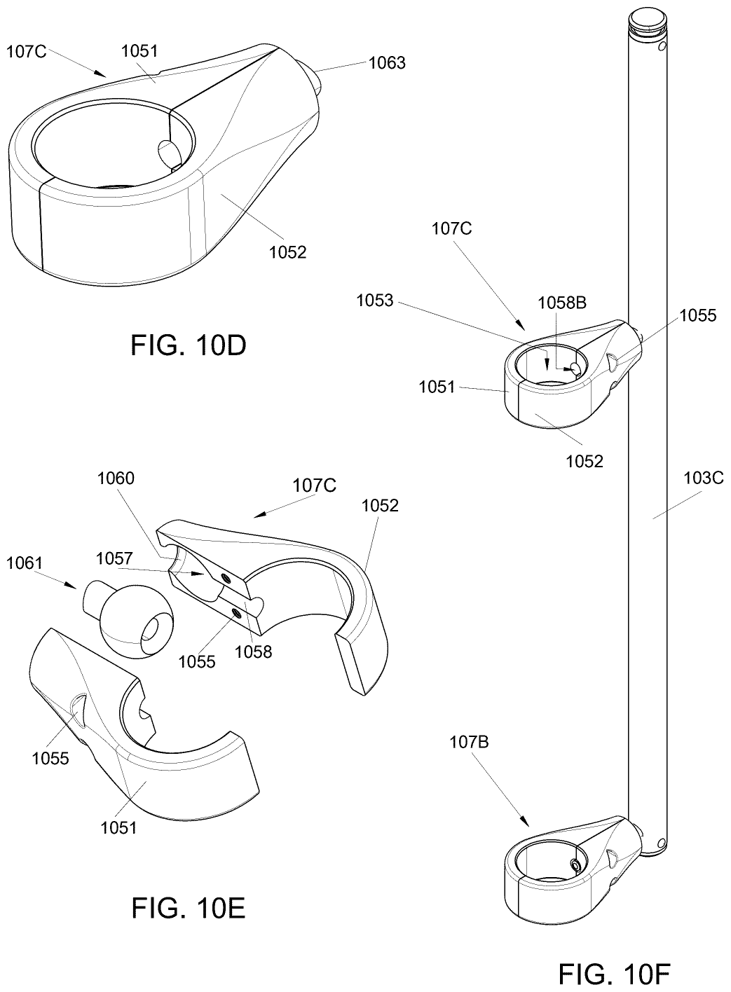

FIGS. 10A and 10B illustrate a perspective view of an example coupling member when together in the clamped position and separated in the opened position, according to an embodiment. In FIGS. 10A and 10B, the example coupling member 107 is shown including body portions 1001 and 1002, which can be separated from each other. When placed together, the body portions 1001 and 1002 form through-holes 1003 and 1004. The body portions 1001 and 1002 can be secured together by screws (not shown) within holes 1005. The coupling member 107 functions to couple or secure the flag housing and deployment system 100 to a structure (e.g., frame or tower) of a boat. For example, the body portions 1001 and 1002 of the coupling member 107 can be separated and then positioned such that the housing 103 is disposed within the through-hole 1004 while the structure (e.g., frame or tower) of the boat is disposed within the through-hole 1003. The body portions 1001 and 1002 can then be secured together with the screws in the holes 1005 to clamp to the housing 103 and to the structure of the boat. The through-hole 1003 can be shaped and sized to the desired structure of the boat. The through-hole 1003 can be circular or elliptical, for example, to be configured to clamp to a frame of a tower of a boat, which is often cylindrical or oblong.

The body portion 1001 also includes a recess 1007 that can provide space for one of the screws 407 used to secure the housing end cap 406 to the housing 103. Similarly, the body portion 1002 includes a similar recess 1007 (not shown in FIG. 10A) that can provide space for the other screw 407. The body portions 1001,1002 also include recesses (or cut outs) that form a through-hole 1008 extending through the body portions 1001,1002 from through-hole 1003 to through-hole 1004.

During assembly, one of the coupling members 107 can be secured to the proximal end of the housing 103 (i.e., with the housing 103 disposed within the through-hole 1004) and to the appropriate structure (e.g., tower or frame) of the boat (i.e., with the structure disposed within the through-hole 1003. More specifically, the body portions 1001,1002 can be separated and placed such that the through-hole 1004 is around the proximal end of the housing 103 with the screws 407 within the recesses 1007, and the air fitting in the port 420b within the recesses forming the through-hole 1008. At the same time, the body portions 1001,1002 can be separated and placed such that the structure is disposed within the through-hole 1003. Screws can then be inserted within the holes 1005 and tightened to clamp the coupling member 107 to the housing 103 and to the structure of the boat, such as structure 301 of FIG. 3. In a similar manner, another coupling member 107 can be clamped to the structure of the boat and to the housing 103 at the other air fitting in port 420a, with the air fitting positioned within the recesses forming the through-hole 1008. One end of the hoses 203a and 203b can then be inserted onto the air fittings at ports 420a and 420b, respectively. The other end of the hoses 203a and 203b can then be connected to the control valve. In other embodiments without hoses for pneumatic actuation, the through-holes 1008 in the coupling member 107 may or may not be implemented. For example, in the embodiment shown in FIG. 2B, the through-hole 1008 in coupling member 107 at the proximal end of the housing 103B can be used to run electrical wiring for communication between the actuation system 151B and the motor 153B. The other coupling member 107 more distally located does not necessarily require a through-hole 1008 to be implemented.

When attaching to a boat or other vehicle, actuation system 151 can be installed at the desired location on the boat. The actuation system 151 can be coupled to the boat in any suitable manner. The actuation system 151 can be fully exposed, partially exposed, or entirely hidden or concealed. For example, the actuation system can be mounted to the tower or frame of the boat, mounted to the deck of the boat, mounted within the paneling of the boat, mounted within a storage compartment on the boat, or custom-built or otherwise integrated within a part of the boat. Once the actuation system is mounted to the boat, the hoses 203a,203b (or electrical wiring, such as for the embodiment shown in FIG. 2B) can be run along or inside the boat to the desired location of the pole and housing assembly 101. In an implementation, the hoses 203a,203b (or electrical wiring) are inserted into the hollow interior of the structure (e.g., tower or frame) of the boat in which the pole and housing assembly 101 will be mounted. The pole and housing assembly 101 can be mounted to the desired location on the structure 301 (e.g., tower or frame) of the boat by clamping the coupling members 107 around the structure at the desire location. Before clamping the coupling members 107, through-holes can be drilled into the structure or frame at the location on the structure 301 that aligns with the through-hole 1008 on each of the coupling members 107. The hoses 203a,203b can be run out of the structure or frame via the drilled holes and subsequently connected to the corresponding air fittings on the ports 420a,420b, respectively. (Similarly, the electrical wiring can be run out of the structure or frame via the drilled holes and subsequently connected to the motor 153B via holes in the housing 103B). The coupling members 107 can then be clamped to both the housing 103 and the structure with the hoses 203a,203b (or electrical wiring) passing through the through-hole 1008 of the coupling member 107. So, the hoses 203a,203b run from the control valve 201 on the actuation system, up through the hollow interior of the structure, out the through-holes drilled into the structure, directly into and through the through-holes 1008 in the coupling members 107, and directly into the air fittings of the ports 420a,420b, respectively. (Similarly, the electrical wiring run from the control system 152B, up through the hollow interior of the structure, out the through-holes drilled into the structure, directly into and through the through-hole 1008 in the coupling member 107 at the proximal end of the housing 103, and directly into the housing 103 via holes in the housing 103B to electrically couple to the motor 153B). In this way, the hoses 203a,203b (or electrical wiring) can remain unexposed to minimize the chance of damage from any users, objects, or environmental elements, and furthermore, can remain hidden which can be aesthetically appealing.

FIGS. 10C, 10D, 10E, and 10F illustrate various views of an example universal coupling member 107C, according to an embodiment. FIG. 10C illustrates an exploded view of the universal coupling member 107C removably coupled to a housing 103C, with a close-up view of the ball and joint shown in Detail A. FIGS. 10D and 10E illustrate the universal coupling member 107C when together in a clamped position and separated in an opened position. FIG. 10F illustrates the universal coupling member 107C coupled to the housing 103C.

In FIGS. 10C, 10D, 10E, and 10F, the example coupling member 107C enables a universal connection of the housing 103C to a structure of a boat (e.g., tower or frame). The universal connection enables different types of coupling members to be removably coupled to a ball joint attached to the housing 103C. In this way, coupling members for differently sized and shaped structures (e.g., towers or frames) on a boat may be coupled to the same ball joint of the same housing of a pole and housing assembly 101. The coupling member 107C is shown including body portions 1051 and 1052, and a through-hole 1053. The body portions 1051 and 1052 are configured to fit together to form the through-hole 1053. The through-hole 1053 can vary in shape and size as needed to fit to various shaped and sized structures on boats. For instance, one coupling member may have a through-hole 1053 shaped and sized to fit large diameter towers or frames, while another coupling member may have a through-hole 1053 shaped and sized differently to fit smaller towers or frames. Further, some through-holes may be circular while other are elliptical or another suitable shape that corresponds to the tower or frame of a certain model or manufacturer. In this way, different coupling members 107C can be made as needed for different models of boats, towers, etc. but can still universally couple to the same pole and housing assembly 101.

The body portions 1051 and 1052 can be secured together by screws (not shown) inserted within holes 1055. The body portions 1051 and 1052 each include a respective recess 1057 that together form a cavity (also referred to herein as “cavity 1057B” to represent the cavity formed by the recesses 1057 even though not shown in FIGS. 10C-F) when the body portions 1051 and 1052 are fit together. This cavity 1057B is configured to receive a ball joint 1061 that is coupled to the housing 103C. The recesses 1057 form an opening 1060 to the cavity 1057B when the body portions 1051 and 1052 are fit together. The body portions 1051 and 1052 each include a respective recess 1058 that form a through-hole 1058B (shown in FIG. 10F) through the body portions 1051 and 1052 from the cavity 1057B to the through-hole 1053. The cavity 1057B formed by the recesses 1057 is configured to couple to the ball joint 1061 on the housing 103C.

The ball joint 1061 can be attached or fixed to the housing 103C at the location of the previously-described holes 410a and 410b, which align with the ports 420a and 420b, respectively. In an embodiment, the ball joint 1061 is welded on to the housing 103. The ball joint 1061 is shown including a stem 1063 and a body portion 1062, which both have a through-hole 1064 passing through the body portion 1062 and the stem 1063. The through-hole 1064 can be configured to receive an air fitting 1065. For example, the air fitting 1065 can be inserted through the through-hole 1064 and corresponding hole 410a,410b to screw into the corresponding port 420a,420b.

The coupling member 107C functions to couple or secure the pole and housing assembly 101 to a structure (e.g., frame or tower) of a boat. For example, the body portions 1051 and 1052 of the coupling member 107B can be separated and then positioned such that the body portion 1062 of the ball joint 1061 is disposed within the cavity 1057B while the structure (e.g., frame or tower) of the boat is disposed within the through-hole 1053. The body portions 1051 and 1052 can then be secured together with screws in the holes 1055 to clamp to the ball joint 1061 and to the structure of the boat. The through-hole 1053 can be shaped and sized to the desired structure of the boat. The through-hole 1053 can be circular or elliptical, for example, to be configured to clamp to a frame of a tower of a boat, which is often cylindrical or oblong.

During assembly, two coupling members 107C can be secured to the two ball joints 1061 at the holes 410a,410b. More specifically, the body portions 1051,1052 can be separated and placed around the ball joints 1061 with the opening 1060 around the stem 1063 of the ball joint 1061, and the air fitting aligned with the through-hole 1058B. The screws 1056 can then be tightened to clamp the coupling member 107C to the ball joint 1061. One end of the hoses 203a and 203b can then be inserted onto the air fittings at ports 420a and 420b, respectively, via the through-holes 1058B. The other end of the hoses 203a and 203b can then run through an opening in the structure of the boat (e.g., holes drilled in the tower or frame of the boat), within the structure, and then connected to the control valve (e.g., the control valve 201 of the actuation system 151A of FIG. 2A).

The actuation system 151 can be attached to the boat in a similar manner as described previously. Once the actuation system 151 is mounted to the boat, the hoses 203a,203b can be run along or inside the boat to the desired location of the pole and housing assembly 101. In an implementation, the hoses 203a,203b are inserted into the hollow interior of the structure or frame of the boat in which the pole and housing assembly 101 will be mounted. The pole and housing assembly 101 can be mounted to the desired location on the structure or frame of the boat by clamping the coupling members 107C around the structure or frame at the desire location. Before clamping the coupling members 107C, through-holes can be drilled into the structure or frame at the location on the structure or frame that aligns with the through-holes 1058B on each of the coupling members 107C. The hoses 203a,203b can be run out of the structure or frame via the drilled holes and subsequently connected to the corresponding air fittings 1065 on the ports 420a,420b, respectively. The coupling members 107C can then be clamped to both the ball joints 1061 and the structure or frame with the hoses 203a,203b passing through the through-holes 1058B of the coupling members 107C. So, the hoses 203a,203b run from the control valve 201 on the actuation system 151, up through the hollow interior of the structure or frame, out the through-holes drilled into the structure or frame, directly into and through the through-holes 1058B in the coupling members 107C, and directly into the air fittings 1065 of the ports 420a,420b, respectively, of the ball joints 1061. In this way, the hoses 203a,203b can remain unexposed to minimize the chance of damage from any users, objects, or environmental elements, and furthermore, can remain hidden which can be aesthetically appealing. The ball joint 1061 and the coupling member 107C can be made from any suitable material, such as metal or metal alloys, including aluminum or aluminum alloy for instance.

In some cases, a boat may include a top or cover that can obstruct the desired placement of the flag housing and deployment system 100. The top or cover of the boat can be a fabric material, often used with a frame structure, to provide shade or covering to users on the boat, such as the case for Bimini tops for instance. Example materials can include, but are not limited to canvas, vinyl, polyester, etc. It should be appreciated that the material can vary in different embodiments without compromising the underlying principles of the trim ring.

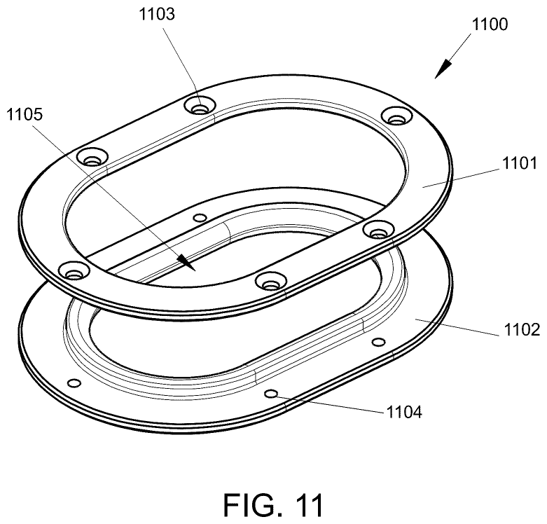

In an embodiment, a trim ring can be used to enable some of the pole and housing assembly 101 to extend through a top or cover on a boat. The trim ring can be used to create a cutout within the top or cover to enable the flag housing and deployment system 100 to extend through the top or cover. FIG. 11 illustrates a perspective view of an example trim ring, according to an embodiment. In FIG. 11, a trim ring 1100 is shown including a top plate 1101 and a bottom plate 1102. Holes 1103 in the top plate 1101 align with holes 1104 in the bottom plate such that screws can be utilized to secure the two plates 1101,1102 together. The top and bottom plates 1101,1102 can vary in shape but includes an interior through-hole 1105 within the perimeter of the plates that will outline the cutout in the top or cover. In the embodiment shown, the plates and interior through-hole 1105 are oval or oblong in shape. To attach the trim ring 1100 to a top or cover, the top plate 1101 can be placed on one side of the top or cover in the desired location where the cutout is desired. The bottom plate 1102 can be placed on the opposite side of the top or cover in the desired location of the cutout. Screws can then be used to secure the two plates 1101,1102 together with the top or cover therebetween. Once the trim ring 1100 is secured in the desired location, the material of the top or cover that is within the interior through-hole 1105 can be cut out by the user. Because the plates 1101 and 1102 are secured with the top or cover between them, the rest of the top or cover remains undisturbed when the cut out is created. The pole and housing assembly 101 can then be operated and extend through the interior through-hole 1105 of the trim ring 1100, thereby extending through and above the top or cover of the boat.

In some implementations, the pole and housing assembly 101 may be secured to the boat below the top or cover when in the housed position, but then the flag 104 is raised through and above the top or cover. In other implementations, the flag housing and deployment system 100 can be secured to the boat with a portion of the flag housing and deployment system 100 extending through and above the top or cover when in the housed position. When deployed, the flag 104 can be raised further above the top or cover of the boat. The shape and size of the trim ring can vary in different embodiments, but should be able to accommodate the portion of the pole and housing assembly 101 that will extend through the cut out.

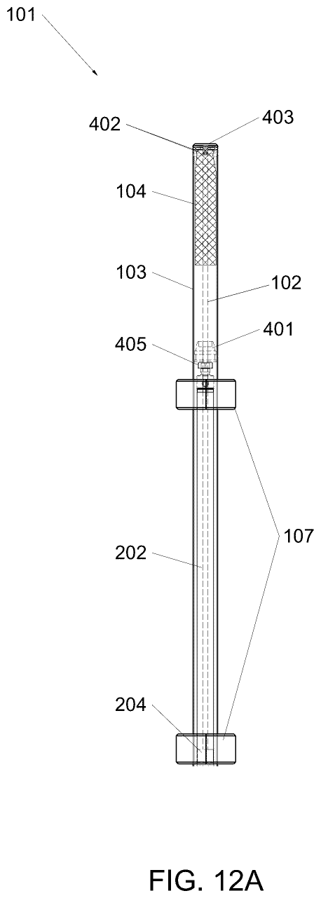

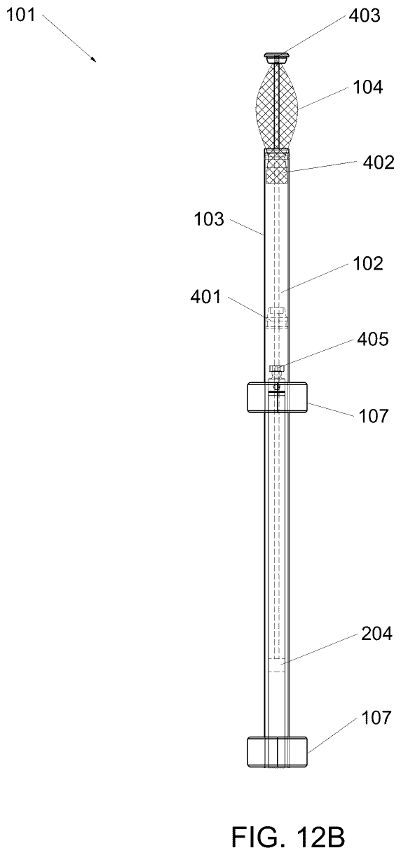

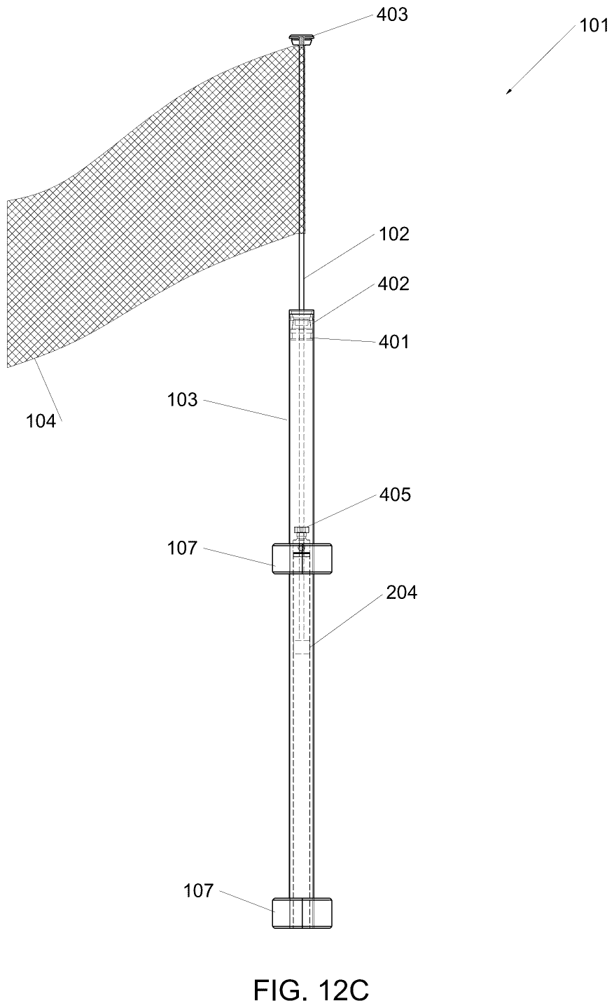

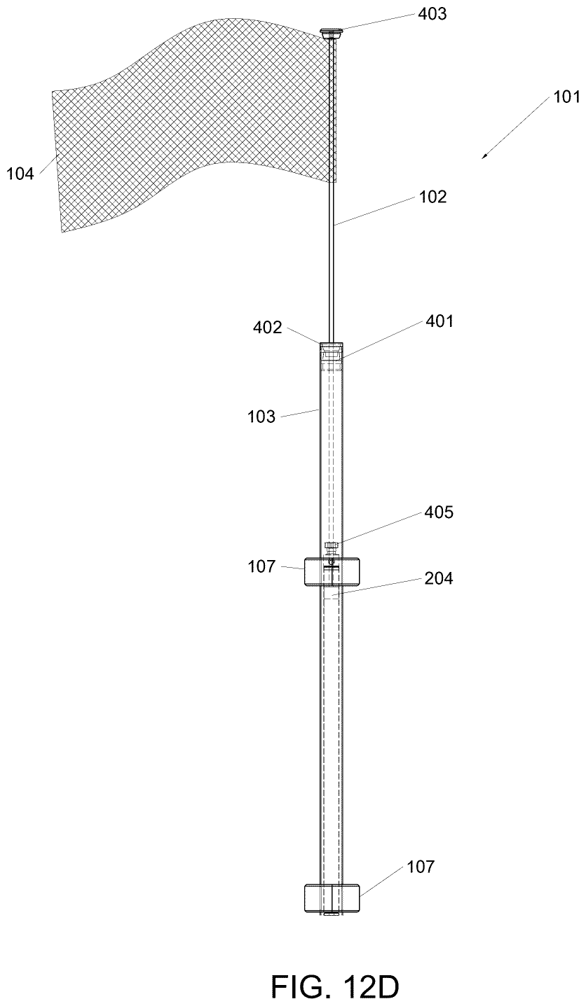

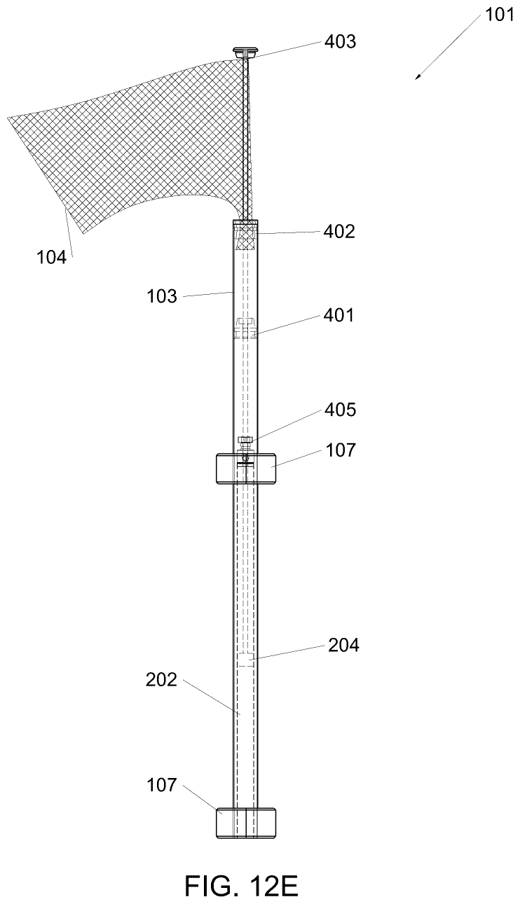

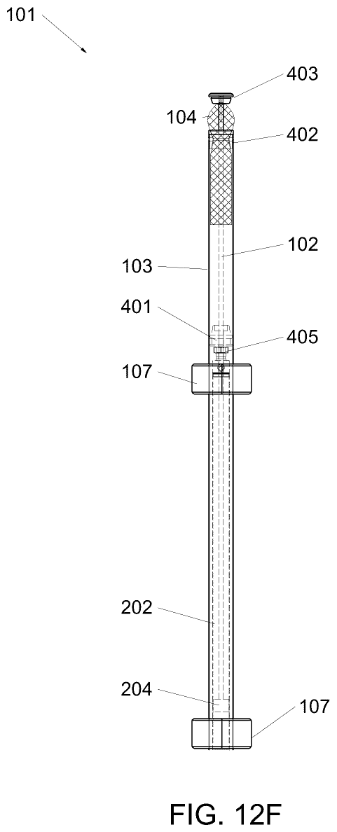

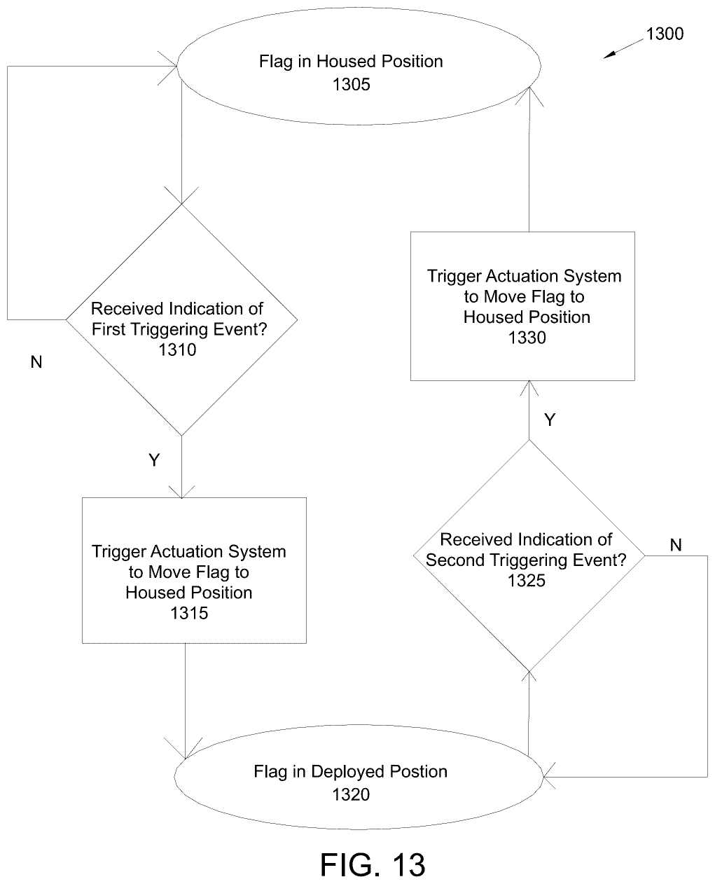

In some aspects of the present disclosure, the pole and housing assembly 101 includes a stabilizing guide 401 that is not fixed to the elongated member 102. The stabilizing guide 401 can move with the elongated member 102 when little to no resistance is applied against the movement of the stabilizing guide 401. The stabilizing guide 401 can remain fixed while the elongated member 102 slides through the stabilizing guide 401 when a threshold level of resistance is applied against the movement of the stabilizing guide 401. FIGS. 12A, 12B, 12C, 12D, 12E, and 12F illustrate side views of an example pole and housing assembly 101 at various stages of deployment, according to an embodiment. In FIGS. 12A-12D, the pole and housing assembly 101 is shown including elongated member 102, the housing 103, the stabilizing guide 401, the stop element 402, the flag 104, the distal end cap 403, the coupling members 107, the air cylinder 202, and the piston 204 coupled to the proximal end of the elongated member 102. In the embodiment shown, the air cylinder 202 is implemented and disposed within the housing 103.

In a first stage shown in FIG. 12A, pole and housing assembly 101 is in the housed position. In the housed position, the flag 104 is fully housed within the housing 103. The elongated member 102 is positioned as far as it will go toward the proximal end of the housing 103 such that the elongated member is within the housing 103. The distal end cap 403 is positioned so that it is closing off the distal end of the housing 103, with the body 902 of the distal end cap 403 inserted within the cavity 803 of the stop element 402. The stabilizing guide 401 is positioned as far as it will go toward the proximal end of the housing 103, resting near the top of the air cylinder 202.

When the flag is deployed upon occurrence of the triggering event, the flag begins to move from the housed position to the deployed position. For example, the actuation system 151 will be activated to push air into the proximal side of the piston and to remove air from the distal side of the piston, thus moving the piston and elongated member 102 distally. In FIG. 12B, the pole and housing assembly 101 is shown in a second stage where the elongated member 102 has started to move distally from the housed position towards the deployed position. In the second stage, the stabilizing guide 401 moves with the elongated member 102 due to the frictional forces between the two. As shown in FIG. 12B, the piston 204 of the elongated member 102, distal end cap 403, and the stabilizing guide 401 have moved approximately the same distance from their respective positions in FIG. 12A. In FIG. 12B, the flag 104 becomes more exposed as it leaves the housing 103 while the elongated member 102 moves distally. The flag 104 may be partially exposed and partially housed during some time during the second stage. In some implementations, the flag 104 may become fully exposed, meaning that the flag is completely out of the housing 103. This may depend on various design factors such as length of the elongated member 102, length of the housing 103, size of the flag 104, distance the elongated member 102 moves, etc.

In FIG. 12C, the flag housing and deployment system 100 is shown in a third stage where the stabilizing guide 401 has contacted the stop element 402. In the third stage, the stabilizing guide 401 remains abutting the stop element 402 and does not move as the elongated member 102 slides through the hole 701 in the stabilizing guide 401. The elongated member 102 continues to move distally to deploy the flag and reach the “deployed position” as represented in FIG. 12D. The flag 104 may be completely outside of the housing 103 during stage three, however, references to the “deployed position” are used herein to refer to the “fully deployed position” where the elongated member 102 has been moved as far distally as it may go, thereby extending the flag as far out of the housing 103 as intended to go.

In the fourth stage shown in FIG. 12D, the flag housing and deployment system 100 is shown in the deployed position where the elongated member 102 is fully extended distally out of the housing 103 with the flag fully deployed. In the deployed position, the stabilizing guide 401 is still abutting the stop element 402. The stabilizing guide 401 works in conjunction with the stop element 402 and the housing 103 to stabilize the elongated member 102 at the distal end of the housing 103. This maximizes the stability of the flag 104 and elongated member 102 extending out of the housing 103 during operation when the boat or vehicle is moving and the wind is blowing.

When the flag is deployed thereafter, such as upon occurrence of the triggering event, the flag begins to move from the fourth stage or deployed position to the first stage or housed position. For example, the actuation system 151 will be activated to push air into the distal side of the piston and to remove air from the proximal side of the piston, thus moving the piston and elongated member 102 proximally.

In FIG. 12E, the flag housing and deployment system 100 is shown in a fifth stage where the elongated member 102 has started to move proximally from the deployed position to the house position. In the fifth stage, the stabilizing guide 401 moves proximally with the elongated member 102 due to the frictional forces between the two. As shown in FIG. 12E, the proximal end of the elongated member 102, distal end cap 403, and the stabilizing guide 401 have moved approximately the same distance from their respective positions in FIG. 12A. In FIG. 12E, the flag 104 enters the housing 103 while the elongated member 102 moves proximally. In embodiments where the flag is generally shaped as a parallelogram or triangle, the flag 104 can enter the housing 103 with less susceptibility to becoming tangled or snagged outside of, or to, the housing 103 as the flag enters the housing 103. The flag 104 may be partially exposed and partially housed during some time during the fifth stage. In some implementations, the flag 104 may become fully housed, meaning that the flag is completely inside of the housing 103. This may depend on various design factors such as length of the elongated member 102, length of the housing 103, size of the flag 104, distance the elongated member 102 moves, etc. While the flag 104 may be completely inside of the housing 103 during the fifth stage, references to the “housed position” are used herein to refer to the “fully housed position” where the elongated member 102 has been moved as far proximally as it may go, thereby housing the flag 104 as far within the housing 103 as it will go with the distal end cap 403 closing off the distal end of the housing 103.

In FIG. 12F, the flag housing and deployment system 100 is shown in a sixth stage where the stabilizing guide 401 has contacted the nut 405 (or housing stabilizer 404). In the sixth stage, the stabilizing guide 401 remains abutting the nut 405 and does not move as the elongated member 102 slides through the hole 701 in the stabilizing guide 401. The elongated member 102 continues to move proximally to reach the “housed position” (or first stage), as represented in FIG. 12A. The operations of 12A-12F can be initiated as necessary to repeatedly deploy and house the flag 104.

I In some aspects of the present disclosure, an actuation system is provided that controls the movement of the pole and housing assembly 101 into the housed and deployed positions based on upon the occurrences of triggering events. FIG. 13 illustrates a flow chart of an example method for activating the flag housing and deployment system to move the flag to the housed position and the deployed position, according to an embodiment. In an embodiment, the method 1300 is performed by the processor 154 of the control system 152 of the actuation system 151, such as shown in FIG. 1. It should be appreciated that some of the components, operations, and techniques previously described herein for FIGS. 1-12 may also be equally applicable to the discussion herein for the example method 1300 of FIG. 13. For the sake of brevity and clarity, not all of the features, operations, and techniques of the common components and operations are repeated here for the method 1300 of FIG. 13. It should be appreciated that the method 1300 is an example and non-limiting, and that variations may be implemented in other embodiments, such as any variations described herein for FIGS. 1-12.

At block 1305 of method 1300, the pole and housing assembly 101 is in the housed position, such as in the first stage described in FIG. 12A. The flag 104 is in fully inside the housing 103 and the distal end cap 403 is positioned so that it closes off the distal end of the housing 103. The pole and housing assembly 101 will remain in the housed position until the occurrence of a “first” triggering event that is predetermined to trigger the flag housing and deployment system 100 to move to the deployed position. For purposes of describing FIG. 13, the triggering event to move to the deployed position may be referred to as the “first” triggering event, while the triggering event to move to the housed position may be referred to as the “second” triggering event.

Example first triggering events may include, but are not limited to, user activation via a user control device (e.g., user initiation of a button, switch, fob, smartphone, tablet, etc.), sensor data representing that a participant is in the water, sensor data representing that a participant riding (or being towed) behind the boat (e.g., a skier, wake boarder, etc.) has fallen or is in the water. The sensor data may be provided by one or more sensors, such as image sensors, proximity sensors, tilt sensors, revolutions per minute (RPM) sensors, global positioning system (GPS) sensors, speed sensors, accelerometer sensors, etc. The image sensor can be used in conjunction with a camera to provide various images. Sensor data, such as image data provided by an image sensor and camera, proximity data provided by a proximity sensor, tilt data provided by an tilt sensor (or an attitude sensor including a tilt sensor); RPM data provided by a RPM sensor, GPS data provided by a GPS sensor, speed data provided by a speed sensor, acceleration data provided by a accelerometer sensor, or any combination thereof, can be received and processed to determine whether a participant riding behind the boat has fallen into the water, or is in the water. It should be appreciated that the processing of the various sensor data and resulting determinations can be performed automatically by the processor such that no user input is required to initiate the movement to the deployed position.

At block 1310, if no indication is received that a first triggering event has occurred, then the pole and housing assembly 101 will remain in the housed position, as represented by the arrow from block 1310 to block 1305. In an embodiment with a pneumatic actuator, the pole and housing assembly 101 is in the stage shown in FIG. 12A. In another embodiment with the linear actuator of FIG. 2B implemented, the pole and housing assembly 101 is in a similar position as shown in FIG. 12A, except the motor 153B, the screw 206, the nut 207, and the two stabilizing elements 208,209 are within the interior of the housing 103. In this embodiment, the stabilizing guide 401 and the air cylinder 202 and its associated components are not implemented. The motor 153B is disposed at the proximal end of the housing 103 with the nut 207 as far proximally positioned and coupled to the elongated member 102. The stabilizing elements 208,209 include respective slots 211,212 that are disposed on the rail 210 of the housing 103.

If, at block 1310, an indication of a first triggering event is received, then at block 1315 the actuation system 151 is triggered (or initiated) to deploy the flag by moving the pole and housing assembly 101 to the deployed position, which is represented by block 1320. For example, one or more of the input devices 155 may send a signal indicating a first triggering event has occurred, such as an indication that the user has pushed a button to deploy the flag; the tilt sensor sends tilt data indicating that the boat has tilted a threshold amount of degrees from a higher tilt angle to a lower tilt angle so as to represent that the boat has decelerated or slowed down because the participant has fallen or is in the water; the proximity sensor sends proximity data indicating that the participant riding behind the boat is not within a certain distance from the boat so as to represent that the participant must have fallen in the water or be in the water; an image sensor or camera sends image data indicating that the participant has fallen or is in the water; an RPM sensor sends RPM data indicating that the RPM of the boat has dropped below a threshold value so as to represent that the boat has decelerated or slowed down because the participant has fallen or is in the water; a GPS sensor sends GPS data indicating that the boat is moving below a threshold speed (e.g., as determined by a decrease in change of location over time) so as to represent that the boat has slowed because the participant has fallen or is in the water; a speed sensor sends speed data indicating that the boat has slowed beyond a threshold value so as to represent that the participant has fallen or is in the water; an accelerometer sensor indicating that the boat has decelerated so as to represent that the participant has fallen or is in the water; etc. The signal from the input devices can be received by the processor 154. When a signal is received that indicates a first triggering event has occurred, the processor 154 can activate the energy source to move the elongated member 102 to the deployed position. For example, in the embodiment with the air cylinder, when the processor 154 receives the indication of a first triggering event, the processor 154 sends an activation signal to the control valve 201 (e.g., solenoid valve) to pump air into proximal side of the piston 204 in the air cylinder 202 via the hose 203b. The air is provided by the compressor and motor 153A. At the same time, air is removed from the distal side of the piston 204 in the air cylinder 202 via the hose 203a. As a result, the elongated member 102 is moved distally to the deployed position, as represented by block 1320. In an embodiment, the pole and housing assembly 101 is moved from the housed position to the deployed position as described in the first through fourth stages of FIGS. 12A-12D. In the embodiment with the linear actuator of FIG. 2B, when the processor 154 receives the indication of a first triggering event, the processor 154 sends an activation signal to the stepper motor which turns the screw in a direction that moves the elongated member distally. Because the slots 211,212 are disposed on the rail 210, the nut 207 does not rotate and moves distally up the screw 206 as the motor turns the screw. Because the elongated member 102 is coupled to the nut 207, the elongated member 102 is moved distally towards the deployed position, with the flag becoming exposed out of the housing.

At block 1320, the pole and housing assembly 101 is in the deployed position, such as in the fourth stage described in FIG. 12D. The elongated member 102 is moved all the way distally with the flag 104 fully deployed. The stabilizing guide 401 and the stop element 402 are abutting at the distal end of the housing 103. The pole and housing assembly 101 will remain in the deployed position until the occurrence of a “second” triggering event that is predetermined to trigger the flag housing and deployment system 100 to move to the housed position. In the embodiment of FIG. 2B with the linear actuator having nut and screw implemented, the pole and housing assembly 101 is in a similar position as shown in FIG. 12D, except the motor 153B, the screw 206, the nut 207, and the two stabilizing elements 208,209 are within the interior of the housing 103. The motor 153B is disposed at the proximal end of the housing 103 with the nut 207 as far distally positioned and coupled to the elongated member 102. The stabilizing element 209 has moved distally and is positioned at the stop element 402 at the distal end of the housing 103. The stabilizing element 208 has moved distally with the nut 207 and traveled an equivalent distance that the stabilizing element 209 has traveled. The flag is fully deployed and outside of the housing 103.

Example second triggering events may include, but are not limited to, user activation via a user control device (e.g., button, switch, fob, etc.), and sensor data representing that a participant is riding behind the boat or out of the water. The sensor data may be provided by one or more sensors, such as the image sensors, proximity sensors, tilt sensors, revolutions per minute (RPM) sensors, GPS sensors, speed sensors, accelerometer sensors, etc. In a similar manner, image data provided by an image sensor and camera, proximity data provided by a proximity sensor, tilt data provided by a tilt (or attitude) sensor, RPM data provided by a RPM sensor, GPS data provided by a GPS sensor, speed data provided by a speed sensor, acceleration data provided by an accelerometer sensor, or any combination thereof, can be received and processed to determine whether a participant is riding behind the boat or out of the water. It should be appreciated that in some embodiments, such as with the image sensor, proximity sensor, tilt sensor, RPM sensor, GPS sensor, speed sensor, and accelerometer sensor, the processing of the various sensor data and resulting determinations can be performed automatically by the processor such that no user input is required to generate a triggering event and to trigger the movement of the flag to the housed position. In instances with the user initiating a control device, such as a remote fob, button, smartphone or tablet button, etc., the processor can receive the data signal from the control device (or may receive the data signal via a receiver or transceiver), and automatically determine when a second triggering event has occurred and trigger the actuation system accordingly.

At block 1325, if no indication is received that one or more of the second triggering events has occurred, then the pole and housing assembly 101 will remain in the deployed position, as represented by the arrow from block 1325 to block 1320. If, at block 1325, an indication of a second triggering event is received, then at block 1330, the actuation system 151 is triggered to house the flag by moving the pole and housing assembly 101 to the housed position, which is represented by block 1305. For example, one or more input devices 155 may send a signal indicating a second triggering event has occurred, such as an indication that the user has pushed a button to house the flag; the tilt sensor sends tilt data indicating that the boat has tilted a threshold amount of degrees from a lower tilt angle to a higher tilt angle so as to represent that the boat has sped up or accelerated and the participant is riding behind the boat; the proximity sensor sends proximity data indicating that the participant is within a certain distance from the boat so as to represent that the participant is riding behind the boat; an image sensor or camera sends image data indicating that the participant is riding behind the boat; an RPM sensor sends RPM data indicating that the RPM of the boat has increased above a threshold value so as to represent that the boat has sped up or accelerated because the participant is riding behind the boat; a GPS sensor sends GPS data indicating that the boat is moving above a threshold speed (e.g., as determined by an increase in change of location over time) so as to represent that the boat has sped up because the participant is riding behind the boat; a speed sensor sends speed data indicating that the boat has sped up above a threshold speed so as to represent that the participant is riding behind the boat; an accelerometer sensor indicating that the boat has accelerated a threshold degree (or amount) so as to represent that the participant is riding behind the boat; etc. The signal from the input devices can be received by the processor 154. When a signal is received that indicates a second triggering event has occurred, the processor 154 can activate the energy source to move the elongated member 102 proximally to the housed position. For example, in the embodiment with the air cylinder, when the processor 154 receives the indication of the second triggering event, the processor 154 sends an activation signal to the control valve 201 (e.g., solenoid valve) to pump air into distal side of the piston in the air cylinder 202 via the hose 203a. The air is provided by the compressor and motor 153A. At the same time, air is removed from the proximal side of the piston in the air cylinder 202 via the hose 203b. As a result, the elongated member 102 is moved proximally to the housed position. In an embodiment, the pole and housing assembly 101 is moved from the deployed position to the housed position as described in the fourth through sixth stages of FIGS. 12D-12F. As the elongated member 102 moves proximally, the flag 104 contacts the housing 103 and is pulled with the housing 103. The shape of the flag 104 can affect how easily the flag 104 is pulled within the housing without getting tangled up or snagged at the opening. In an embodiment, the flag 104 is shaped as a parallelogram to facilitate smooth entry into the housing 103. In the embodiment of FIG. 2B with the linear actuator, when the processor 154 receives the indication of the second triggering event, the processor 154 sends an activation signal to the stepper motor which turns the screw in the opposite direction than it turned to reach the deployed position. Because the slots 211,212 are disposed on the rail 210, the nut 207 does not rotate and moves proximally down the screw 206 as the motor turns the screw. Because the elongated member 102 is coupled to the nut 207, the elongated member 102 is moved proximally to the housed position and eventually pulls the flag 104 within the housing 103.

The pole and housing assembly 101 will remain in the housed position until the occurrence of another first triggering event that is predetermined to trigger the flag housing and deployment system 100 to move to the deployed position. The process can then be repeated for additional first and second triggering events that occur.

The first and second triggering events can be programmed or defined as desired. For example, in an implementation, a triggering event can be a single event that triggers the move to the housed or deployed position. In another implementation, the occurrence of more than one event may trigger the move to the housed or deployed position. In yet another implementation, the occurrence of any one of a first group of events may trigger the move to the housed or deployed position, but the occurrence of more than one of a second group of events may trigger the move to the housed or deployed position. In some implementations, specific combinations of events may be required to trigger the move to the deployed position.

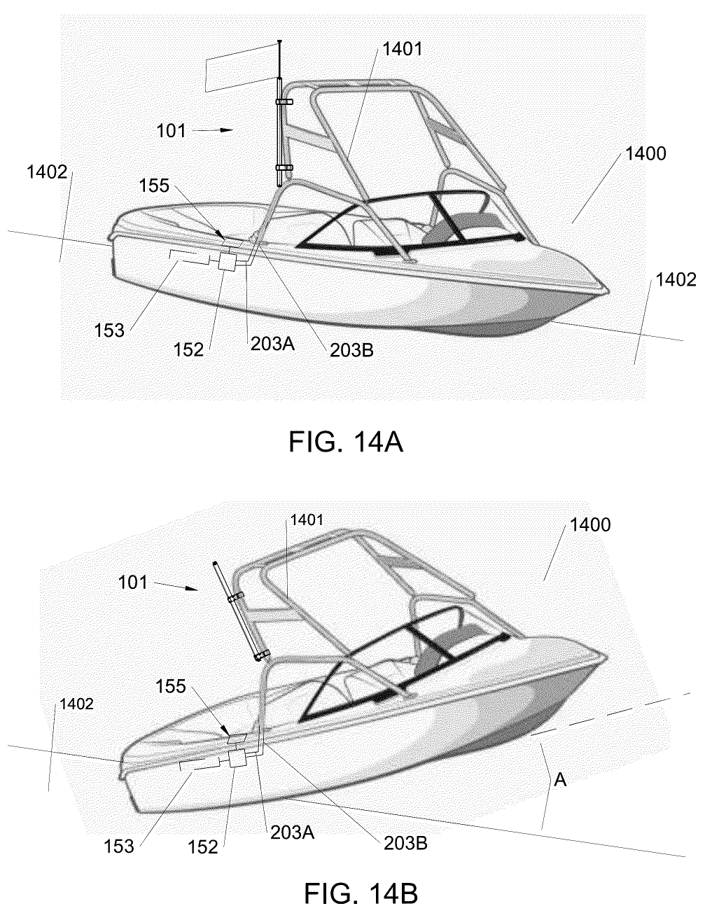

FIGS. 14A and 14B illustrate diagrams of an example implementation of a tilt sensor on a boat for a flag housing and deployment system. In FIGS. 14A and 14B, a boat 1400 is shown having the pole and housing assembly 101 coupled to the tower 1401 of the boat 1400, and the actuation system 151 attached to the inside of the hull or paneling of the boat 1400.

In FIG. 14A. the boat 1400 is level (or below a threshold degree or angle A, such as shown in FIG. 14B) with the water 1402 representing that a participant riding behind the boat (e.g., a skier, wake boarder, etc.) has fallen and is in the water, or that the boat 1400 is stopped in the water. For example, the boat can be stopped in the water because the participant is in the water getting ready to ride behind the boat, or because the boat is significantly decelerating because the participant has fallen into the water. The actuation system 151 includes a tilt sensor 155 as an input device. The tilt sensor detects the tilt of the boat and sends this as tilt data to the processor 154 on the control system 152. The tilt sensor sends this tilt data to the processor 154. The processor 154 receives and processes the tilt data to determine that the tilt is level, below the threshold angle A, or has tilted a threshold amount of degrees from a higher tilt angle to a lower tilt angle, so as to represent that the boat has slowed down and the participant has fallen or is in the water, and thus indicating that a first triggering event has occurred. The processor then, based on the determination that the first triggering event has occurred, activate the actuation system to automatically move the elongated member 102 to the deployed position, which fully deploys the flag 104.

In FIG. 14B, the boat 1400 is tilted or angled above a specific threshold degree or angle A from the water 1402, representing that a participant is riding behind the boat. For example, in order for a participant to be pulled out of the water and start riding, the boat must be throttled or accelerated, causing the boat to tilt above the threshold angle A. Furthermore, as the boat continues to pull the participant, the boat remains above the threshold angle A. The processor 154 on the control system 152 receives and determines that the tilt of the boat is above the threshold angle A or that it went from a lower tilt angle to a higher tilt angle, so as to represent that the boat has increased and the participant is riding behind the boat. The processor 154 then determines that the second triggering event has occurred because the boat is tilted greater than a second threshold degree of tilt. The second threshold degree of tilt does not necessarily have to be the same as the first threshold degree of tilt. The processor 154 then, based on the determination that the second triggering event has occurred, activates the actuation system 151 to automatically move the elongated member 102 to the housed position, which fully houses the flag 104 within the housing 103.

It should be appreciated that the angle A can be set as desired for various factors, such as weight of the user, the specifications of the boat, the given application or sport, such as wake boarding, skiing, etc. Example threshold values for angle A may include, but are not limited to, a value in the range of 15 degrees or greater, including 30 degrees or greater, 45 degrees or greater, and 60 degrees or greater. The location of the tilt sensor can be implemented in any suitable location on the boat. It should also be appreciated that in one embodiment, different values for the threshold angle A may be implemented to house the flag versus deploy the flag.

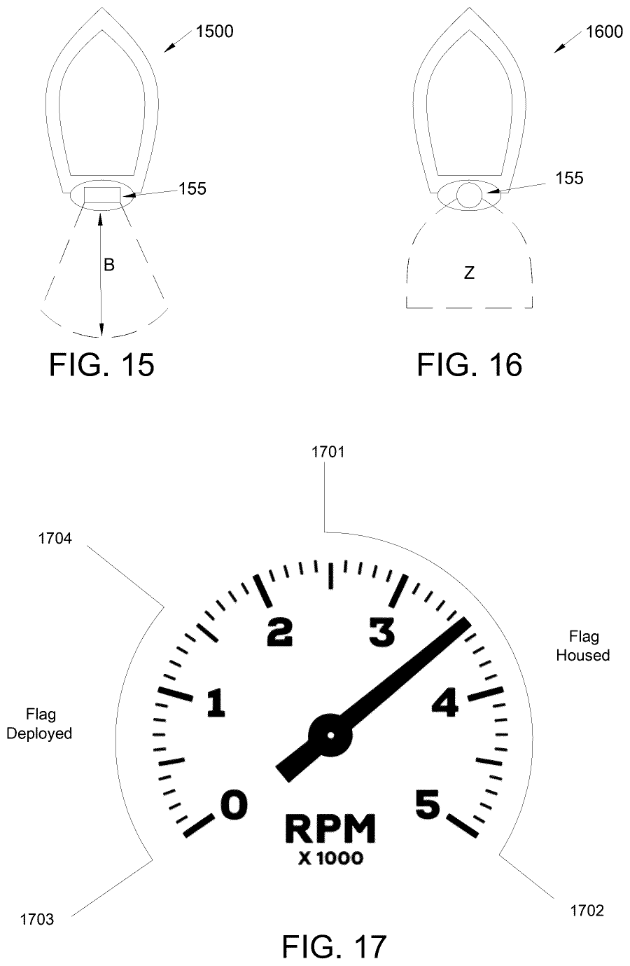

FIG. 15 illustrate diagrams of an example implementation of a proximity sensor on a boat for a flag housing and deployment system. In FIG. 15, a boat 1500 is shown from a top view and includes a proximity sensor 155 as an input device to the actuation system 151. The location of the proximity sensor 155 can be implemented in any suitable location, such as at or near the rear of the boat or tower for instance. The proximity sensor detects when a person is within a proximity of the boat, such as within a threshold distance B from the boat, which would represent that a participant is riding behind the boat. The proximity sensor may be oriented such that it measures the proximity relative to an area above the water level, so as to avoid detecting participants within the water. The proximity sensor 155 detects, as proximity data, that the proximity or distance of the user from the boat and sends the proximity data to the processor 154. The processor 154 receives and processes the proximity data to determine that the proximity of the participant is greater than the threshold distance B—representing that the person behind the boat has entered the water and not riding behind the boat—and thus the first triggering event has occurred. The processor 154 then, based on the determination that the first triggering event has occurred, activates the actuation system 151 to automatically move the elongated member to the deployed position and fully deploy the flag 104. On the other hand, when the processor 154 determines that a participant is within a threshold distance B from the boat—representing that the participant behind the boat is riding behind the boat—the processor 154, based on the determination that the second triggering event has occurred, activates the actuation system to automatically move the elongated member to the housed position and fully house the flag 104.

It should be appreciated that the threshold distance B can be set as desired for various factors, such as weight of the user, the specifications of the boat or tow rope, the given application or sport, such as wake boarding, skiing, etc. Example threshold values for distance B may include, but are not limited to, a value of 10 feet, 25 feet, 50 feet, 75 feet, and 100 feet.

FIG. 16 illustrate diagrams of an example implementation of an image sensor and camera on a boat for a flag housing and deployment system. In FIG. 16, a boat 1600 is shown from a top view and includes a camera and image sensor 155 as an input device to the actuation system 151. The location of the camera and image sensor 155 can be implemented in any suitable location, such as at or near the rear of the boat or tower for instance. The camera and image sensor generates image data for an area or zone Z behind the boat. In an embodiment, the camera and image sensor may be oriented such that it generates image data for a zone Z that is above the water level, so as to avoid detecting persons within the water. In another embodiment, the camera and image sensor may generate image data for a zone Z that encompasses above and within the water, so as to also detect when the participant is within the water. The camera and image sensor 155 detects, as image data, information or attributes of the person behind the boat, and then sends this image data to the processor 154.

The processor 154 receives and processes the image data to determine if a first triggering event has occurred—e.g., the participant has entered the water or fallen into the water and not riding behind the boat (e.g., the position of the person at or below the water level, or that the participant is not detectable within the image (or specific area or zone within an image) which may indicate that the person is below the water or beyond the zone B). In such case, the processor 154 can, based on the determination that the first triggering event has occurred, activate the actuation system to automatically move the elongated member to the deployed position and fully deploy the flag 104.

If the processor 154 determines from the image data that the second triggering event has occurred—e.g., that the participant has started riding behind the boat (e.g., positioned above the water level, standing generally vertical or erect, positioned within a specific area or zone of the image, etc.), then the processor 154 can, based on the determination that the second triggering event has occurred, activate the actuation system to automatically move the elongated member to the housed position and fully house the flag 104.

It should be appreciated that the size or dimensions of the zone Z can be set as desired for various factors, the specifications of the boat or tow rope, the given application or sport, such as wake boarding, skiing, etc. Example sizes of zone Z may include, but are not limited to, 10 feet, 25 square feet, 50 square feet, and 75 square feet.

FIG. 17 illustrate diagrams of an example implementation of an RPM sensor on a boat for a flag housing and deployment system. In FIG. 17, an example RPM range for an engine of a boat is shown. In the example shown, the RPM values range from 0 to 5000 RPMs. It should be appreciated that RPM values may vary depending on the engine implemented. An RPM sensor 155 can be implemented as an input device to the actuation system 151 on a boat. The location of the RPM sensor 155 can be implemented in any suitable location, such as in the hull or paneling of the boat for instance. For example, the RPM sensor can be electrically coupled to the RPM gauge or circuitry, or configured to communicate with a digital RPM sensor, in order to receive the RPM value of the engine. The RPM sensor 155 can detect, as RPM data, the RPMs of the engine and send the RPM data to the processor 154. The processor 154 can receive and process the RPM data to determine whether the RPM of the boat has dropped below a threshold value so as to represent that the boat has decelerated or slowed down because the participant has fallen or is in the water, or whether the RPM of the boat has increased above a threshold value so as to represent that the boat has sped up because the participant is riding behind the boat. For example, a determination that a person is riding behind the boat can be represented by RPM values above a minimum threshold (e.g., 2500 RPMs shown at reference numeral 1701), or within an elevated threshold range (e.g., 2500 to 5000 RPMS shown between reference numerals 1701 and 1702). Upon such a determination, the processor 154 can, based on the determination that the first triggering event has occurred, activate the actuation system to automatically move the elongated member to the deployed position to fully house the flag. The processor 154 can also determine from the RPM data if the participant has fallen or is in the water. For example, a determination that a participant has fallen into the water or is in the water can be represented by RPM values below a minimum threshold (e.g., 1500 RPMs shown at reference numeral 1704), or within a minimum threshold range (e.g., 0 to 1500 RPMS shown between reference numerals 1703 and 1704). Upon such a determination, the processor 154 can, based on the determination that the second triggering event has occurred, activate the actuation system to automatically move the elongated member to the deployed position and fully deploy the flag.

It should be appreciated that the threshold values or ranges of RPMs for the deployment and housing of the flag provided above are example and can vary in different implementations. For instance, the threshold values or ranges of RPM can each be set as desired for various factors, the weight of the participant, the specifications of the boat or tow rope, the given application or sport, such as wake boarding, skiing, etc.

Similarly to the RPM sensor, other sensors (e.g., GPS sensor, speed sensor, accelerometer, etc.) may be implemented to determine whether the sensor data represents that the boat has decelerated or slowed down because the participant has fallen or is in the water, or whether the corresponding sensor data represents that the boat has sped up or accelerated because the participant is riding behind the boat.

For example, determinations that the participant has fallen or is in the water can be derived from a GPS sensor sending GPS data indicating that the boat is moving below a threshold speed (e.g., as determined by a decrease in change of location over time); from a speed sensor sending speed data indicating that the boat has slowed down to a threshold speed; from an accelerometer sensor indicating that the boat has decelerated beyond a threshold value; etc. On the other hand, determinations that the participant is riding being the boat can be derived from the GPS data indicating that the boat is moving above a threshold speed (e.g., as determined by an increase in change of location over time); from the speed data indicating that the boat has sped up to a threshold speed; from an accelerometer sensor indicating that the boat has accelerated to a threshold value; etc.

Furthermore, it should be appreciated that all the previously-described sensors and the first and second triggering events can be programmed or set in any suitable or desired manner without compromising the underlying principles of the present disclosure. For example, a time delay may be implemented along with the sensors to allow time for the participant to be pulled out of the water and to successfully begin riding behind the boat. For example, an increase in tilt to the threshold amount may be required to be held for 3 seconds, 5 seconds, 10 seconds, etc., before a determination is made that the second triggering event has occurred and the flag should be housed. This gives the participant time to be fully pulled out of the water and to successfully begin riding behind the boat before the flag is housed. The time delay can be similarly applied to other sensors, including the proximity data, image and camera data, RPM data, GPS data, speed data, accelerometer data, etc.

In one embodiment, the control system (e.g., the control system 152) can include a pulse delivery circuit that enables a momentary pulse to be delivered based on one or more input devices (e.g., local or remote user control devices, including wired and wireless user control devices such as a remote button, FOB, smartphone, etc.) described herein. The user control devices can be, for example, one or more wired remote buttons that a user on the boat can depress or otherwise actuate to deploy and house the flag. In an embodiment, a user control device can have a single button that is used to both deploy and house the flag. In such case, a pulse delivery circuit can be configured to receive momentary pulses that cause the circuit to toggle between deploying and housing the flag. The pulse delivery circuit can also be configured to provide a state indicator representing the current state of the position of the flag as either deployed (or raised, up, etc.) and housed (or lowered, down, etc.). In one embodiment, the pulse delivery circuit is configured to provide a momentary pulse to be delivered based on sensor data from one or more sensors.

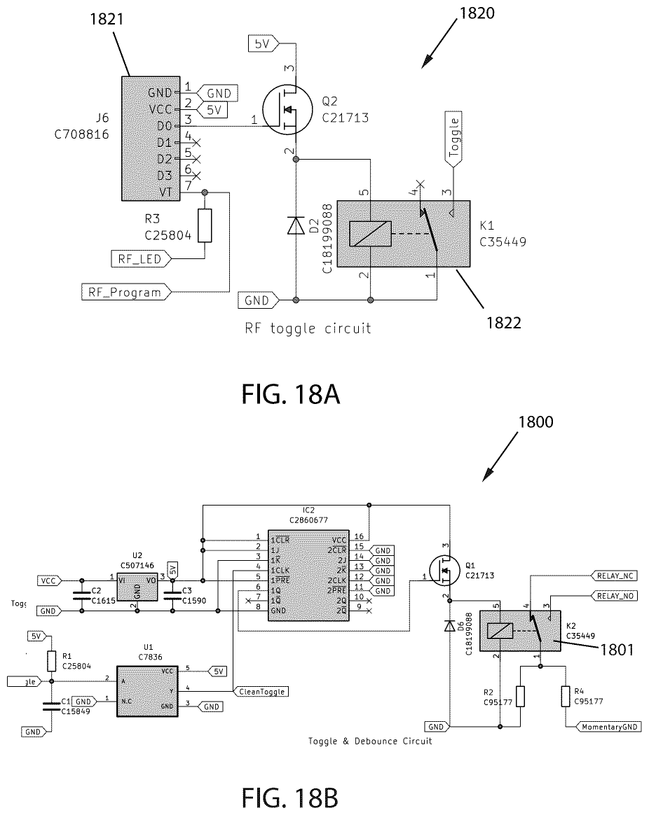

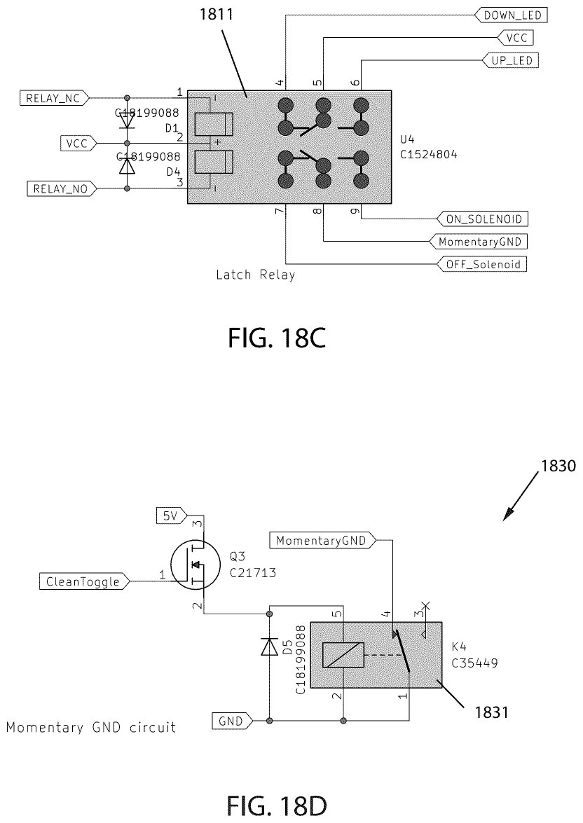

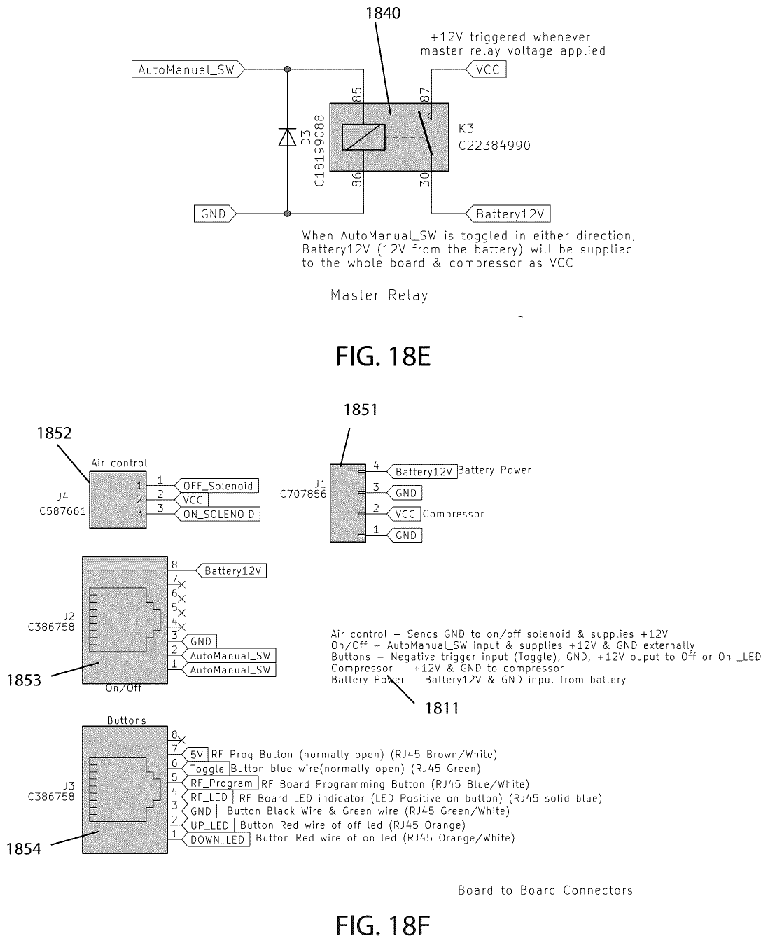

FIGS. 18A, 18B, 18C, 18D, 18E, and 18F (collectively referred to as FIG. 18) illustrate schematics for parts of a pulse delivery circuit of a control system (e.g., the control system 152). The pulse delivery circuit is configured to serve as a power source that provides power for an indication of the current state of position (e.g., housed or deployed positions), such as by providing power to light one or more LEDs (or same or different colors), symbols, texts, icons, etc. In the embodiment shown in FIG. 18, the pulse delivery circuit includes a RF toggle circuit, a toggle and debounce circuit, a latch relay, a momentary ground circuit, a master relay, and various connectors on the circuit board.

The RF toggle circuit is configured to receive a RF or wireless signal from a user control device (e.g., a remote FOB, smartphone, etc.) and transmits a corresponding toggle signal to a toggle and debounce circuit to raise and lower the flag. FIG. 18A illustrates an example RF toggle circuit, according to an embodiment. In FIG. 18A, a RF toggle circuit 1820 is shown including a RF module 1821 and a RF relay 1822. The RF module 1821 can be a programmable RF receiver, for instance, that receives a signal from the user control device, such as a remote FOB. The RF relay 1822 outputs a “toggle” signal (shown as signal TOGGLE) (to indicate a “button press” signal to raise or lower the flag)) based on the signal received from the RF module 1821.

The toggle and debounce circuit receives the “toggle” signal from the RF toggle circuit that causes a toggle relay to toggle and send a corresponding “relay signal” that alternates between a normally open relay signal (shown as signal RELAY_NO) and a normally closed relay signal (shown as signal RELAY_NC) with each toggle. If a wired user control device is used instead, or in addition to a wireless user control device, the wired user control device can transmit a similar “toggle” signal to the toggle and debounce circuit, such as via a cable to a connector on the board (e.g., connector 1854). Moreover, if one or more sensors is used instead, or in addition to a user control device, a similar “toggle” signal can be configured to be sent to the toggle and debounce circuit based on the sensor data from the one or more sensors.

FIG. 18B illustrates an example toggle and debounce circuit, according to an embodiment. In FIG. 18B, a toggle and debounce circuit 1800 is shown including a toggle relay 1801 that flip flops based on the toggle signal received form the RF toggle circuit or from the wired user control device—e.g., at each button press. The toggle relay 1801 flip flops to generate the alternating relay signal. The toggling feature enables the ability to use a single button to trigger up and down signals to deploy and house the flag, respectively.

A latch relay receives the alternating (or switching) “relay” signal from the toggle and debounce circuit and sends a corresponding alternating signal to the solenoid to turn the solenoid off (shown as signal OFF_Solenoid) and on (shown as signal ON_Solenoid) in order to raise and lower the flag via the compressor and air cylinder. The latch relay also sends an alternating state indicator signal to power and indicate the appropriate state of position (shown as signals UP_LED and DOWN_LED) for the flag as raised or lowered (or deployed or housed)—e.g., by sending a signal to light a corresponding LED, symbol, text, color, etc. FIG. 18C illustrates an example latch relay, according to an embodiment. In FIG. 18C, a bi-stable relay 1811 (or latch relay) is shown. Instead of returning to a rested state when power is removed, the bi-stable relay 1811 “remembers” or keeps track of the position of the flag when power is off. This can be useful, for example, when a boat is parked for some time with the power off and flag up. The bi-stable relay 1811 allows the state indicator to remain as it was before the power was turned off. The bi-stable relay 1811 is shown having two connections—one for the light indications for up and down (shown as signals UP_LED and DOWN_LED), and on and off signals to the air solenoid for up and down (shown as signals ON_Solenoid and OFF_Solenoid), for which ever the cycle is. It should be appreciated that the state indicator light could be programmed off and on and “remembered” using a digital chip or circuit in another embodiment.

A momentary ground circuit is provided for debounce purposes and helps provide a stable signal to ensure that a single press of release of a user control device results in only one clean signal change. FIG. 18D illustrates an example momentary ground circuit, according to an embodiment. In FIG. 18D, a momentary ground circuit 1830 is shown including a clean toggle relay 1831. The clean toggle relay 1831 takes the cleaned up toggle (shown as signal CleanToggle) and provides a predictable momentary toggle (shown as signal MomentaryGND) that has enough capacity for all the functions.

A master relay functions to provide power to the pulse delivery circuit board and compressor for operation. FIG. 18E illustrates an example master relay, according to an embodiment. In FIG. 18E, a master relay 1840 is shown and functions as the main power relay. When the main “on-off” switch of the control system is switched “on,” the master relay 1840 sends power to the compressor as well as all the pulse delivery circuit board components.

FIG. 18F illustrates various example connectors that can be used on the pulse delivery circuit board, according to an embodiment. In FIG. 18F, connectors 1851, 1852, 1853, and 1854 are shown. The connector 1851 is the power connector for receiving voltage (e.g., 12V) and power from the battery of the boat or vehicle, and providing voltage and a high amperage output for operating the compressor. The signal to operate the solenoid for air control is sent via the connector 1852. The connector 1853 is a connector to the main “on-off” switch, and may be a RJ45 connector (or alternatively, a RJ11 or RJ12 connector) for example. The wires of the RJ45 connection can be used to carry the 12 volts and the power indication light for “on-off”. The connector 1854 is the connector for the up and down switches, and can be a RJ45 connector for example. The eight wires of the RJ45 connector can be used. Four wires can be configured for normal operation to carry a negative 12 volt signal to send a negative pulse to trigger the up and down signals. Three wires can be configured for RF programming. An adaptor can be plugged into this connector to input the sequence to program RF remotes for instance. The adaptor setup can be utilized to add or replace RF remotes without having to disassemble the main unit. It should be appreciated that the functions of the pulse delivery circuit can be implemented in other suitable manners, such as with digital or programmable circuitry, including microprocessors, controllers, etc., in other embodiments.

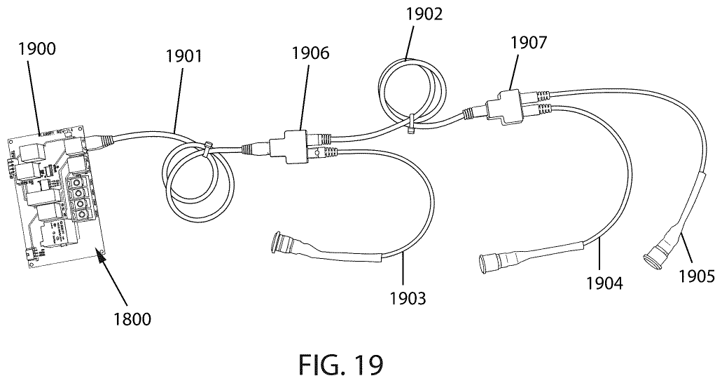

FIG. 19 illustrates and diagram of an example daisy chain configuration of more than one user-input device using category cables (e.g., Ethernet cables, such as CAT5 or CAT6) to couple to the rest of the control system of the flag and housing deployment system. In FIG. 19, a board 1900 with the pulse delivery circuit 1800 of FIG. 18 is shown coupled to a daisy chained configuration of CAT6 cables 1901 and 1902 and user control devices (e.g., remote user buttons) 1903, 1904, and 1905. The cable 1901 is connected to a connector (e.g., the connector 1854) of the pulse delivery circuit board and to an input side (or single connector side) of a splitter 1906. The splitter 1906 splits the signal on the output side (or multiple connector side) to the CAT6 cable 1902 and to the user control device 1903. The CAT6 cable 1902 is then connected to an input side of a splitter 1907. The splitter 1907 splits the signal on the output side (or multiple connector side) to the user control device 1904 and to the user control device 1905. When the user activates any one of the user control devices 1903, 1904, and 1905 (e.g., depresses a single button on the remote device), the corresponding TOGGLE signal is sent to the toggle and debounce circuit 1800 via the connector 1854 in order to activate movement of the flag between the deployed and housed position. The pulse delivery circuit described in FIGS. 18A-18F enable each of the user control devices 1903, 1904, and 1905 to appropriately activate the movement of the flag to the next position. It should be appreciated that although three user control devices are shown, another number of the user control devices (e.g., 2, 4, 5, 6, etc.) can be implemented in a similar fashion via the daisy-chained configuration and the appropriate number of splitters required.

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques. Also, embodiments can include various operations as set forth above, fewer operations, or more operations; or operations in an order. Accordingly, the scope and spirit of the invention should be judged in terms of the claims, which follow as well as the legal equivalents thereof.

What is claimed is:

1. A flag housing and deployment system, comprising:
a housing comprising a hollow interior between a proximal end and a distal end of the housing;
an elongated member positioned within the housing and configured to couple to a flag at a distal end of the elongated member; and
an actuation system operably coupled to the elongated member, wherein the actuation system is configured to:
move the elongated member from the housed position to a deployed position based on an occurrence of a first triggering event; and
move the elongated member from the deployed position to a housed position based on an occurrence of a second event;
wherein, in the deployed position, the elongated member extends out of the distal end of the housing such that the flag and the distal end of the elongated member are outside of the housing; and
wherein, in the housed position, the elongated member is positioned within the housing such that the flag is housed within the housing.

2. The flag housing and deployment system of claim 1, further comprising:
a stabilizing guide positioned within the housing and configured to move within the housing, wherein the stabilizing guide comprises a hole extending through the stabilizing guide, and wherein the elongated member is positioned extending through the hole of the stabilizing guide; and
a stop element coupled to the housing and configured to contact and stop the stabilizing guide when sliding towards the distal end of the housing;
wherein the elongated member and the stabilizing guide are configured such that movement of the elongated member from the housed position to the deployed position comprises:
the elongated member moving with the stabilizing guide towards the distal end of the housing until the stop element contacts and stops the stabilizing guide; and
after the stop element contacts and stops the stabilizing guide, the elongated member continues to move and slides through the hole of the stabilizing element to reach the deployed position.

3. The flag housing and deployment system of claim 2, wherein the elongated member and the hole are frictionally fit, and wherein the frictional fit is overcome when the stop element contacts and stops the stabilizing guide during movement of the elongated member from the housed position to the deployed position.

4. The flag housing and deployment system of claim 2, wherein the stabilizing guide occupies the cross-sectional area of the housing.

5. The flag housing and deployment system of claim 1, wherein the actuation system comprises:
an energy source for providing energy to move the elongated member to the housed and deployed positions;
one or more input devices; and
a processor communicatively coupled to the energy source and the one or more input devices, wherein the processor is configured to:
receive input from one or more input devices;
determine when the first and second triggering events occur based on the input;
trigger movement of the elongated member, using the energy, to the deployed position based on a determination that the first triggering event has occurred; and
trigger movement of the elongated member to the housed position, using the energy, based on a determination that the second triggering event has occurred.

6. The flag housing and deployment system of claim 5, further comprising an air cylinder having a piston coupled to the elongated member;
wherein the actuation system comprises:
a compressor and a motor as the energy source; and
a control valve coupled to the compressor and to the air cylinder via hoses to enable air from the compressor to enter the air cylinder to move the piston in opposite directions.

7. The flag housing and deployment system of claim 5, further comprising:
a motor as the energy source;
a screw coupled to the motor; and
a nut threaded to fit on the screw;
wherein the nut is coupled to the elongated member and prevented from rotating within the housing; and
wherein the nut is configured to move in opposite directions within the housing based on a direction that the motor rotates the screw.

8. The flag housing and deployment system of claim 5, further comprising a linear actuator configured to move the elongated member to the housing and deployed positions.

9. The flag housing and deployment system of claim 5, wherein the one or more input devices comprise a local or remote device that enables a user to indicate the occurrence of the first and second events via the local or remote device, and wherein the input received by the processor comprises input from the local or remote device.

10. The flag housing and deployment system of claim 9, wherein the one or more input devices are configured to provide a state indicator to indicate the deployed and housed positions via at least one selected from: a light source, LED, icon, symbol, color, and text.

11. The flag housing and deployment system of claim 10, wherein the one or more input devices comprises a remote button having an integrated state indicator to indicate the deployed and housed positions via the at least one selected from: a light source, LED, icon, symbol, color, and text.

12. The flag housing and deployment system of claim 10, wherein more than one of the input devices are daisy-chained with category (or CAT) cables.

13. The flag housing and deployment system of claim 5, wherein the one or more input devices comprise one or more sensors, and wherein the input received by the processor comprises sensor data from the one or more sensors.

14. The flag housing and deployment system of claim 13, wherein the one or more sensors comprises at least one selected from the group consisting of: a revolutions per minute (RPM) sensor, a tilt sensor, a proximity sensor, an image sensor, a global positioning system (GPS) sensor, a speed sensor, and an accelerometer sensor.

15. The flag housing and deployment system of claim 14, wherein the one or more sensors comprise the image sensor for generating image data of a participant behind a boat, and wherein the processor is configured to:
receive and process the image data from the image sensor;
based on the processing of the image data, determine that the first triggering event has occurred, wherein the first triggering event represents that the participant behind the boat is in the water and not riding behind the boat; and
based on the determination that the first triggering event has occurred, trigger the actuation system to move the elongated member to the deployed position.

16. The flag housing and deployment system of claim 15, wherein the processor is further configured to:
based on the processing of the image data, determine that the second triggering event has occurred, wherein the second triggering event represents that the participant is riding behind the boat; and
based on the determination that the second triggering event has occurred, trigger the actuation system to move the elongated member to the housed position.

17. The flag housing and deployment system of claim 14, wherein the one or more sensors comprise the proximity sensor for generating proximity data of a participant behind a boat, and wherein the processor is configured to:
receive and process the proximity data from the proximity sensor;
based on the processing of the proximity data, determine that the first triggering event has occurred, wherein the first triggering event represents that the participant behind the boat is in the water and not riding behind the boat; and
based on the determination that the first triggering event has occurred, trigger the actuation system to move the elongated member to the deployed position.

18. The flag housing and deployment system of claim 17, wherein the processor is further configured to:
based on the processing of the proximity data, determine that the second triggering event has occurred, wherein the second triggering event represents that the participant is riding behind the boat; and
based on the determination that the second triggering event has occurred, trigger the actuation system to move the elongated member to the housed position.

19. The flag housing and deployment system of claim 14, wherein the one or more sensors comprise the tilt sensor for generating tilt data of a boat, and wherein the processor is configured to:
receive and process the tilt data from the tilt sensor;
based on the processing of the proximity data, determine that the first triggering event has occurred, wherein the first triggering event represents that the boat is tilted less than a first threshold degree of tilt; and
based on the determination that the first triggering event has occurred, trigger the actuation system to move the elongated member to the deployed position.

20. The flag housing and deployment system of claim 19, wherein the processor is further configured to:
based on the processing of the tilt data, determine that the second triggering event has occurred, wherein the second triggering event represents that the boat is tilted greater than a second threshold degree of tilt; and
based on the determination that the second triggering event has occurred, trigger the actuation system to move the elongated member to the housed position.

21. The flag housing and deployment system of claim 14, wherein the one or more sensors comprise the revolutions per minute (RPM) sensor for generating RPM data of a boat, and wherein the processor is configured to:
receive and process the RPM data from the RPM sensor;
based on the processing of the proximity data, determine that the first triggering event has occurred, wherein the first triggering event represents that an engine of the boat has decreased below a first threshold value of RPMs; and
based on the determination that the first triggering event has occurred, trigger the actuation system to move the elongated member to the deployed position.

22. The flag housing and deployment system of claim 21, wherein the processor is further configured to:
based on the processing of the RPM data, determine that the second triggering event has occurred, wherein the second triggering event represents that the engine of the boat has increased above a second threshold value of RPMs; and
based on the determination that the second triggering event has occurred, trigger the actuation system to move the elongated member to the housed position.

23. The flag housing and deployment system of claim 14, wherein the one or more sensors comprise the global positioning system (GPS) sensor for generating GPS data of a boat, and wherein the processor is configured to:
receive and process the GPS data from the GPS sensor;
based on the processing of the GPS data, determine that the first triggering event has occurred, wherein the first triggering event represents that a speed or acceleration of the boat has decreased below a first threshold value; and
based on the determination that the first triggering event has occurred, trigger the actuation system to move the elongated member to the deployed position.

24. The flag housing and deployment system of claim 23, wherein the processor is further configured to:
based on the processing of the GPS data, determine that the second triggering event has occurred, wherein the second triggering event represents that the speed or acceleration of the boat has increased above a second threshold value; and
based on the determination that the second triggering event has occurred, trigger the actuation system to move the elongated member to the housed position.

25. The flag housing and deployment system of claim 14, wherein the one or more sensors comprise the speed sensor for generating speed data of a boat, and wherein the processor is configured to:
receive and process the speed data from the speed sensor;
based on the processing of the speed data, determine that the first triggering event has occurred, wherein the first triggering event represents that a speed of the boat has decreased below a first threshold value; and
based on the determination that the first triggering event has occurred, trigger the actuation system to move the elongated member to the deployed position.

26. The flag housing and deployment system of claim 25, wherein the processor is further configured to:
based on the processing of the speed data, determine that the second triggering event has occurred, wherein the second triggering event represents that the speed of the boat has increased above a second threshold value; and
based on the determination that the second triggering event has occurred, trigger the actuation system to move the elongated member to the housed position.

27. The flag housing and deployment system of claim 14, wherein the one or more sensors comprise the accelerometer sensor for generating acceleration data of a boat, and wherein the processor is configured to:
receive and process the acceleration data from the accelerometer sensor;
based on the processing of the acceleration data, determine that the first triggering event has occurred, wherein the first triggering event represents that an acceleration of the boat has decreased below a first threshold value; and
based on the determination that the first triggering event has occurred, trigger the actuation system to move the elongated member to the deployed position.

28. The flag housing and deployment system of claim 27, wherein the processor is further configured to:
based on the processing of the acceleration data, determine that the second triggering event has occurred, wherein the second triggering event represents that the acceleration of the boat has increased above a second threshold value; and
based on the determination that the second triggering event has occurred, trigger the actuation system to move the elongated member to the housed position.

29. The flag housing and deployment system of claim 5, wherein the one or more input devices comprise two or more sensors; wherein the input received by the processor comprises sensor data from the two or more sensors; and wherein the two or more sensors are selected from the group consisting of: an image sensor, a proximity sensor, an attitude sensor, and a revolutions per minute (RPM) sensor;
wherein the processor is further configured to:
based on the processing of data from the two or more sensors, determine that the first triggering event has occurred; and
based on the determination that the first triggering event has occurred, trigger the actuation system to move the elongated member to the deployed position.

30. The flag housing and deployment system of claim 29, wherein the processor is further configured to:
based on the processing of data from the two or more sensors, determine that the second triggering event has occurred; and
based on the determination that the second triggering event has occurred, trigger the actuation system to move the elongated member to the housed position.

31. The flag housing and deployment system of claim 5, further comprising:
an air cylinder having a piston coupled to the elongated member;
wherein the actuation system comprises:
a compressor and a motor as the energy source; and
a control valve coupled to the compressor and to the air cylinder via hoses to enable air from the compressor to enter the air cylinder to move the piston in opposite directions;
wherein the air cylinder comprises:
a first port disposed on one side of the piston to move the piston in a first direction; and
a second port disposed on an opposite side of the piston to move the piston in a second direction opposite the first direction;
first and second hoses coupled to the compressor and extending to the first and second ports, respectively; and
one or more coupling members coupled to the housing and configured to couple to a structure of a boat.

32. The flag housing and deployment system of claim 31, further comprising a flag coupled to the distal end of the elongated member.

33. The flag housing and deployment system of claim 5, further comprising:
an air cylinder having a piston coupled to the elongated member;
wherein the actuation system comprises:
a compressor and a motor as the energy source; and
a control valve coupled to the compressor and to the air cylinder via hoses to enable air from the compressor to enter the air cylinder to move the piston in opposite directions;
wherein the air cylinder comprises:
a first port disposed on one side of the piston to move the piston in a first direction; and
a second port disposed on an opposite side of the piston to move the piston in a second direction opposite the first direction;
first and second hoses coupled to the compressor and extending to the first and second ports, respectively; and
first and second clamps coupled to the housing and configured to couple to a structure of a boat;
wherein the first clamp comprise a first hole for receiving the first hose;
wherein the second clamp comprise a second hole for receiving the second hose;
wherein the first hole is configured to align with a third hole in the housing such that the first hose is extendable from within the structure of the boat to the first port of the cylinder in the housing; and
wherein the second hole is configured to align with a fourth hole in the housing such that the second hose is extendable from within the structure of the boat to the second port of the cylinder within the housing.

34. The flag housing and deployment system of claim 33, further comprising a flag coupled to the distal end of the elongated member.

35. The flag housing and deployment system of claim 5, wherein the housing is integrated in a structure of a boat.

36. The flag housing and deployment system of claim 35, further comprising an air cylinder having a piston coupled to the elongated member;
wherein the actuation system comprises:
a compressor and a motor as the energy source; and
a control valve coupled to the compressor and to the air cylinder via hoses to enable air from the compressor to enter the air cylinder to move the piston in opposite directions.

37. The flag housing and deployment system of claim 36, wherein the one or more input devices comprise a local or remote device that enables a user to indicate the occurrence of the first and second events via the local or remote device, and wherein the input received by the processor comprises input from the local or remote device.

38. The flag housing and deployment system of claim 36, wherein the one or more input devices comprise one or more sensors; wherein the input received by the processor comprises sensor data from the one or more sensors; wherein the one or more sensors comprises at least one selected from the group consisting of: a revolutions per minute (RPM) sensor, a tilt sensor, a proximity sensor, an image sensor, a global positioning system (GPS) sensor, a speed sensor, and an accelerometer sensor.

39. The flag housing and deployment system of claim 35, further comprising a linear actuator configured to move the elongated member to the housing and deployed positions.

40. The flag housing and deployment system of claim 39, wherein the one or more input devices comprise a local or remote device that enables a user to indicate the occurrence of the first and second events via the local or remote device, and wherein the input received by the processor comprises input from the local or remote device.

41. The flag housing and deployment system of claim 39, wherein the one or more input devices comprise one or more sensors; wherein the input received by the processor comprises sensor data from the one or more sensors; wherein the one or more sensors comprises at least one selected from the group consisting of: a revolutions per minute (RPM) sensor, a tilt sensor, a proximity sensor, an image sensor, a global positioning system (GPS) sensor, a speed sensor, and an accelerometer sensor.

42. The flag housing and deployment system of claim 35, further comprising a flag coupled to the distal end of the elongated member.

43. The flag housing and deployment system of claim 1, further comprising a flag coupled to the distal end of the elongated member.

44. The flag housing and deployment system of claim 43, wherein the flag has a shape of a parallelogram.

45. The flag housing and deployment system of claim 43, wherein the flag comprises a sleeve to fit over the elongated member.

46. The flag housing and deployment system of claim 43, wherein the flag comprises a zipper or a hook and latch connection that enables the flag to be removed.

47. The flag housing and deployment system of claim 43, further comprising a trim ring having a top and bottom plate that are configured to couple to opposite sides of a fabric material of a top or cover of a boat to enable:
the fabric material within the interior of the top and bottom rings to be cut out without disturbing the rest of the top or cover; and
the elongated member to extend through the top or cover of the boat via the interior of the top and bottom plates in the deployed position.

48. A machine-implemented method for housing and deploying a flag of a flag housing and deployment system, the method comprising:
receiving input from one or more input devices of the flag housing and deployment system, wherein the flag housing and deployment system comprises:
a housing comprising a hollow interior between a proximal end and a distal end of the housing;
an elongated member positioned within the housing and configured to couple to a flag at a distal end of the elongated member; and
an actuation system operably coupled to the elongated member, wherein the actuation system is configured to:
move the elongated member from the housed position to a deployed position based on an occurrence of a first triggering event; and
move the elongated member from the deployed position to a housed position based on an occurrence of a second event;
wherein, in the deployed position, the elongated member extends out of the distal end of the housing such that the flag and the distal end of the elongated member are outside of the housing; and
wherein, in the housed position, the elongated member is positioned within the housing such that the flag is housed within the housing;
wherein the actuation system comprises:
an energy source for providing energy to move the elongated member to the housed and deployed positions; and
the one or more input devices;
determining when the first and second triggering events has occurred based on the input;
triggering movement of the elongated member, using the energy from the energy source, to the deployed position based on a determination that the first triggering event has occurred; and
triggering movement of the elongated member to the housed position, using the energy, based on a determination that the second triggering event has occurred.
